(19) United States
(12) Patent Application Publication
(10) Pub. No.: US 2013/0262853 A1
(43) Pub. Date: Oct. 3, 2013

(54) SERVER APPARATUS, CLIENT APPARATUS, AND REQUEST PROCESSING METHOD

(71) Applicant: Hiroaki ARIE, Tokyo (JP)

(72) Inventor: Hiroaki ARIE, Tokyo (JP)

(73) Assignee: NEC Corporation

(21) Appl. No.: 13/839,086

(22) Filed: Mar. 15, 2013

(30) Foreign Application Priority Data
Mar. 28, 2012 (JP) 2012-074921

(51) Int. Cl. H04L 29/06

(52) U.S. Cl. CPC H04L 63/0428
USPC 713/150

(57) ABSTRACT

An object of the present invention is to reduce a processing load on a server apparatus in a web system which provides contents to a client apparatus on the basis of an access authority of the client apparatus.

A server apparatus which provides contents to a client apparatus based on an access authority set on the client apparatus, the server apparatus including: an encryption unit which encrypts information for displaying the contents by the client apparatus, such that the client apparatus can decrypt it; a first generation unit which generates decryption information for a specific user, the decryption information being used for decrypting the encrypted information, and used by the client apparatus for the user; a second generation unit which generates decryption information for all the users by combining the decryption information for the specific users; and a transmission unit which transmits the encrypted information and the decryption information for all the users to the client apparatus in response to the access from the client apparatus.

This application is based upon and claims the benefit of priority from Japanese Patent Application No. 2012-074921, filed on Mar. 28, 2012, the disclosure of which is incorporated herein in its entirety by reference.

### TECHNICAL FIELD

The present invention relates to a server apparatus, a client apparatus and a request processing method in a web system, and in particular, it relates to request processing.

### BACKGROUND ART

In web systems, it is widely operated to provide user terminals (client apparatuses) with contents, which are mutually different among those of the user terminals, on the basis of access authorities of users who operate the user terminals. For example, in a portal system as one type of such web systems, it is widely known to arrange and display a plurality of small display screens, each called a portlet, on a display screen, called a portal page, to user terminal in accordance with a user's way of operating the user terminal (for example, refer to FIG. 2).

Information such as texts or graphics in the portal page (hereinafter, referred to as contents) are mainly displayed inside the frames of portlets. However, the contents are also displayed outside the frames of portlets (for example, in a space portion outside the frames of portlets A to G within a portal page 200 for a portal-page administrator, as shown in FIG. 2).

And, the contents displayed on the portal page include external contents acquired from an external server, in addition to contents provided by the portal server (a server apparatus) itself In general, when a user terminal accesses the portal page of the portal server, the portal server collects contents stored in the portal server itself and contents stored in external servers, combines the collected contents so that the contents can be arranged within a portal-page display screen in a easily viewable way; and transmits the combined contents to the user terminal. The transmitted portal page is displayed on a display unit of the user terminal.

Such portal system sets an access authority, such as permission or non-permission of display for each portal page or each portlet to a user terminal or a user who operates a user terminal. The portal system can make each user terminal display mutually different screen view in response to request from different user terminal to the same portal page.

The portal server which receives a request regarding a portal page determines whether or not there is an access authority set on a requesting user terminal (or a user of the requesting user terminal) to each the portal page and portlets included in the portal page. Then, the portal server generates a portal page by consolidating information which the requesting user terminal has an access authority, and transmits the generated portal page to the user terminal. The user terminal displays the received portal page on its display screen (a display unit).

In addition, the above processing for generating a portal page includes processing for determining locations of respective information which has an access authority, processing for generating contents to be displayed on the portal page, processing for collecting contents from an external server in accordance with necessity, and processing for consolidating the generated and collected contents.

Accordingly, when the portal server receives requests for accesses to a portal page from a large number of user terminals, or when there are many portlets included in the portal page, the processes of determining the access authorities and generating the portal page are concentrated on the portal server, loads on the portal server increase, and response speed of the portal server lowers.

For this reason, technologies for decreasing this processing concentration on a portal server are proposed.

As an example of such technologies, in Japanese Translation of PCT International Application Publication No. 2010-511214 (hereinafter, referred to as patent literature 1), a technology in which a portal server consolidates information of portlets included in a portal page and transmit it to a client, and the client renders the information of portlets is disclosed.

And, in Japanese Translation of PCT International Application Publication No. 2007-536655 (hereinafter, referred to as patent literature 2), a technology in which a client apparatus (a user terminal) prefetchs portal information in advance of a user's request and caches it in the client apparatus, is disclosed.

Alternatively, a client apparatus described in Japanese Patent Application Laid-Open No. 2005-025389 (hereinafter, referred to as patent literature 3) receives encrypted contents from a content provision server. Then, after confirming that the content of a ticket received from the client apparatus is correct, the content provision server transmits a decryption key for the provided contents to the client apparatus. The client apparatus decrypts the already provided contents with the received decryption key.

And, in Japanese Unexamined Patent Application Laid-Open No. 2002-007347 (hereinafter, referred to as patent literature 4), a technology in which a data center, not a portal site, manages access restrictions is disclosed.

In the technology disclosed in patent literature 1, the client apparatus combines content information of portlets. Accordingly, the portal server can reduce a processing load for combining content information. However, the portal server needs to provide the client apparatus with layout information for specifying which portlet is to be arranged at which position of the portal page. Accordingly, the portal server needs to perform processing for determining access authorities for a portal page, each portlet and contents, and processing for configuring layouts of portlets (processing for determining locations of portlets on a display screen). Thus, in the technology disclosed in patent literature 1, there is a problem that the load of the portal server increases at the time when the portal server has received a request from a user terminal.

And, in the technology disclosed in patent literature 2, the client apparatus shares parts of the processing for combining content information of portlets. This sharing of the client enables reduction of a processing load of the portal server. However, the client apparatus needs to acquire an access authority about the propriety of displaying portlet from the portal server. And, the client apparatus also needs to acquire display locations of elements, such as portlets, within a portal page, from the portal server. That is, the portal server needs to perform processing for determining access authorities of a user regarding each portal page, portlet, and contents, and processing for configuring layouts of the portal page. Thus, in the technology disclosed in patent literature 2, there is a problem that a load of the portal server increases at the time when the portal server receives an access request from a user terminal.

And, the technology disclosed in patent literature 3 makes processing for determining access authorities of the portal server unnecessary on the basis of the encryption of contents when the client acquires contents. However, when the client apparatus acquires a decryption key for the encrypted contents, the portal server needs to perform processing for determining an access authority of the client apparatus with respect to the decryption key. Thus, in the technology disclosed in patent literature 3, there is a problem that a load of the portal server increases.

And, in the technology disclosed in patent literature 4, there is a problem that a data center is needed besides a portal site.

### SUMMARY

An object of the present invention is to reduce a processing for determining access authorities of a client apparatus, and processing for combining contents on the server apparatus.

According to an aspect of the present invention, a server apparatus which provides contents to a client apparatus on the basis of an access authority which is set on a user of the client apparatus in a web system, the server apparatus including: an encryption unit which encrypts information for displaying the contents by the client apparatus which is given an access authority to the user of the client apparatus, such that the client apparatus can decrypt it; a first generation unit which generates decryption information for a specific user, the decryption information being used for decrypting the encrypted information which is given the access authority for the client apparatus, and used by the client apparatus for the user who is given the access authority and a client apparatus for other user who is given the access authority same as the user; a second generation unit which generates decryption information for all the users by combining the decryption information for the specific users according to the client apparatus; and a transmission unit which transmits the information encrypted by the encryption unit and the decryption information for all the users to the client apparatus in response to the access from the client apparatus.

According to another aspect of the invention, a client apparatus which is used in a web system and displays contents on the basis of an access authority set on a user of the client apparatus, the client apparatus including: an acquisition unit which acquires decryption information for the client apparatus from decryption information received from a server apparatus; a decryption unit which decrypts information which can be decrypted by using the decryption information for the client apparatus among encrypted information received from the server apparatus; and a display unit which combines the information decrypted by the decryption unit and displays it on a display screen.

According to a further aspect of the invention, a request processing method for a server apparatus which provides contents to a client apparatus on the basis of an access authority which is set on a user of the client apparatus, the request processing method including: encrypting necessary information for displaying the contents by the client apparatus; generating decryption information for decrypting encrypted information which is given the access authority for the client apparatus among the encrypted information; and transmitting the encrypted information and the decryption information to the client apparatus when the client apparatus transmits a request for contents to the server apparatus.

### BRIEF DESCRIPTION OF THE DRAWINGS

Exemplary features and advantages of the present invention will become apparent from the following detailed description when taken with the accompanying drawings in which:

FIG. 1 is a block diagram illustrating an example of the configuration of a system according to the first exemplary embodiment of the present invention.

FIG. 2 is a diagram illustrating an example of a screen display of the portal page.

FIG. 3 is a diagram illustrating an example of the structure of data stored by the portal server according to the first exemplary embodiment of the present invention.

FIG. 4 is a diagram illustrating an example of the structure of data which the server provides to the client apparatus, according to the first exemplary embodiment of the present invention.

FIG. 5 is a flowchart illustrating an example of operation of updating the encrypted portal information, according to a first exemplary embodiment of the present invention.

FIG. 6 is a flowchart illustrating an example of operation of request processing to the portal page according to the first exemplary embodiment of the present invention.

FIG. 7 is a flowchart illustrating an example of operation of data configuration processing of portal information performed by a client, according to the first exemplary embodiment of the present invention.

FIG. 8 is a diagram illustrating an example of the data structure of an encrypted portal page, according to the first exemplary embodiment of the present invention.

FIG. 9 is a diagram illustrating an example of relations among users using the client apparatuses, access authorities and decryption keys, according to the first exemplary embodiment of the present invention.

FIG. 10 is a diagram illustrating an example of information which is transmitted to the client apparatus, according to the first exemplary embodiment of the present invention.

FIG. 11 is a flowchart illustrating an example of operation of encryption processing of the portal page information, according to the first exemplary embodiment of the present invention.

FIG. 12 is a diagram illustrating an example of the structure of data which is provided to the client apparatus, according to the second exemplary embodiment of the present invention.

FIG. 13 is a block diagram illustrating an example of the configuration of a server apparatus according to the third exemplary embodiment of the present invention.

FIG. 14 is a block diagram illustrating an example of the configuration of a client apparatus according to the third exemplary embodiment of the present invention.

FIG. 15 is a block diagram illustrating an example of the configuration of the server apparatus according to the third exemplary embodiment of the present invention.

### EXEMPLARY EMBODIMENT

Hereinafter, exemplary embodiments of the present invention will be described in detail with reference to the drawings.

### First Exemplary Embodiment

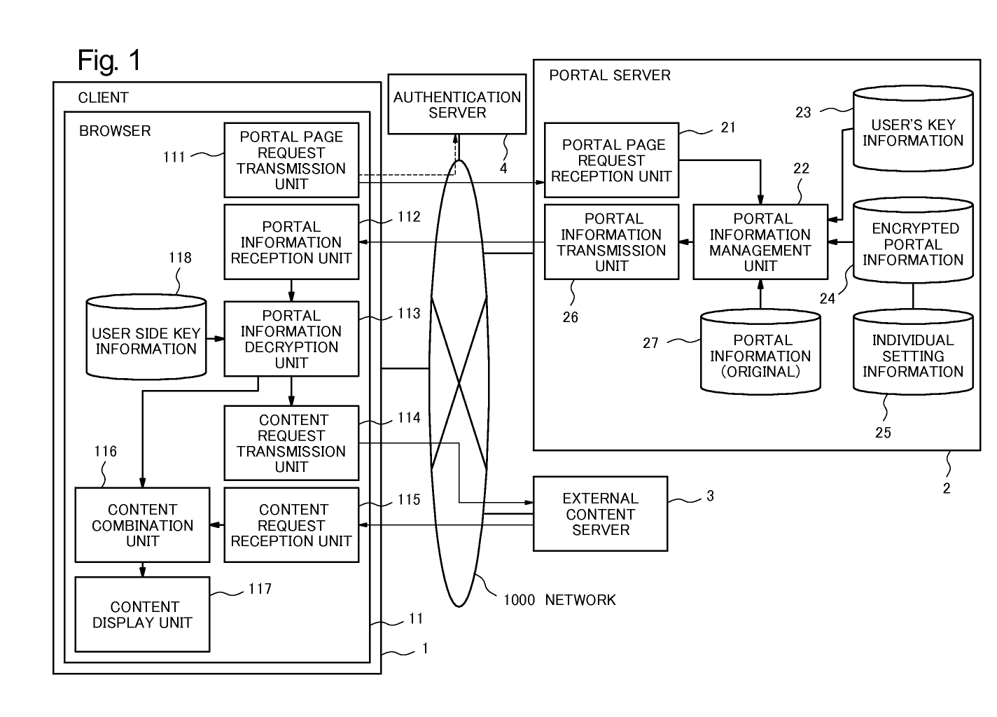

FIG. 1 is a block diagram illustrating an example of the configuration of a web system according to a first exemplary embodiment of the present invention.

In addition, the type of a server apparatus according to this exemplary embodiment is not limited to a particular one, and thus, the following description will be made using a portal server as an example. Accordingly, a web system according to this exemplary embodiment described below is made a portal system.

And, data handled in this exemplary embodiment is not limited to particular data, and thus, the following description will be made using a portal page including portlets as an example. Then, the requests which the portal server receives from the client apparatus are “a request to a portal page” and “a request for generation and update of portal information or an access authority”. And, as having been already described above, contents are an aggregate of pieces of information which is displayed on a portal page or a portlet.

In addition, hereinafter, sometimes, “a server apparatus” and “a client apparatus” will be referred to as just “a server” and “a client”, respectively. And, since “a client” is an apparatus used by a user, it will be sometimes abbreviated to just “a user”.

Referring to FIG. 1, the web system according to this exemplary embodiment includes a client 1 (a client apparatus), a portal server 2 (a server apparatus), an external content server 3, an authentication server 4 and a communication network 1000.

The client 1, the portal server 2, the external content server 3 and the authentication server 4 communicate with one another via the communication network (hereinafter, referred to as just “a network”) 1000, such as a local area network (LAN) or an internet.

The client 1, the portal server 2, the external content server 3 and the authentication server 4 may be each realized by employing a general information processing apparatus (a computer apparatus) which operates on a program control basis, or may be each realized by employing dedicated hardware.

The external content server 3 stores external contents. Then, in response to a request for acquisition of external contents from the client 1, the external content server 3 transmits the external contents to the client 1.

The authentication server 4 authenticates the client 1 or the user using the client 1. (Hereinafter, “authentication of the client 1” and “authentication of the user using the client 1” will be collectively referred to as “user authentication.) The authentication server 4 is, for example, a server which performs user authentication at the time when a browser 11, which is a software operating on the client 1, has accessed the portal server 2. In addition, the authentication server 4 may be a server which has functions equivalent to those of an authentication server operating in a general web system. And, the authentication server 4 may also perform user authentication at the time when the client 1 accesses the external content server 3.

The portal server 2 includes a portal page request reception unit 21, a portal information management unit 22, user's key information 23, encrypted portal information 24, individual setting information 25, a portal information transmission unit 26 and portal information (original) 27.

The user's key information 23, the encrypted portal information 24, the individual setting information 25 and the portal information (original) 27 are stored in, for example, a data storage area of a storage unit (not illustrated) included in the portal server 2. However, however, a storage area for each of information described above is not limited to the data storage area of the portal server 2. For example, a part of or the whole of each of information described above may be stored in an external storage apparatus (not illustrated) which is connected to the portal server 2.

The user's key information 23, the encrypted portal information 24, the individual setting information 25 and the portal information (original) 27 will be described below again.

The portal page request reception unit 21 receives a request to the portal server 2 from the client 1.

The portal information management unit 22 configures data to be transmitted to the client 1 on the basis of the encrypted portal information 24 and the individual setting information 25, in response to the request to the portal page from the client 1.

And, the portal information management unit 22 generates or updates the encrypted portal information 24 on the basis of the user's key information 23 and the portal information (original) 27, in response to a request for generation and update of the portal information or the access authority from the client 1.

The portal information transmission unit 26 transmits data configured by the portal information management unit 22 to the client 1.

Here, in order to describe the structure of the information stored in the portal server 2, first, an image of utilization of the portal system according to this exemplary embodiment will be described.

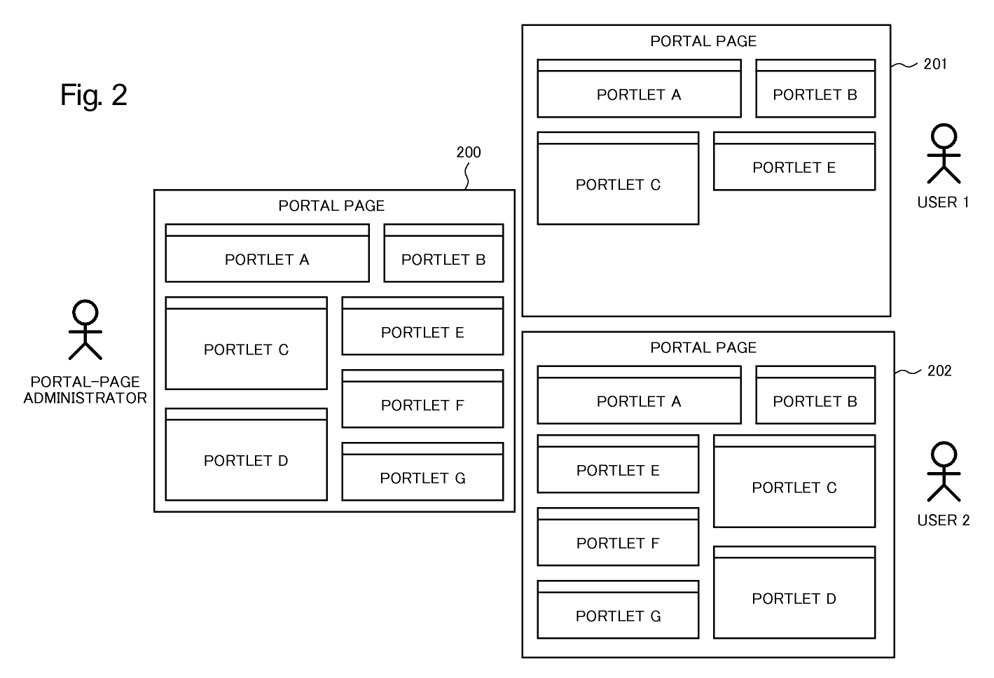

FIG. 2 is a diagram illustrating an example of a screen display for the portal page according to this exemplary embodiment.

FIG. 2 indicates a portal page 200 for a portal-page administrator, a portal page 201 for a user 1 and a portal page 202 for a user 2.

First, it is supposed that a portal page stored by the portal server 200 includes seven portlets A to G just like the portal page 200 for the portal-page administrator, as shown in FIG. 2. (For example, the portal server 2 operated by a portal-page administrator, who is not restricted at all in accesses to the portal server 2, displays the portal page 200 for the portal-page administrator.)

It is supposed that, when the client 1 of the user 1 accesses the same portal page as the portal page 200 for a portal-page administrator, the client 1 corresponding to the user 1 does not display the portlets D, F and G, as shown in the portal page 201 for the user 1.

Moreover, it is supposed that, when a second client 1 of a different user 2 accesses the same portal page as the portal page 200 for a portal-page administrator, the second client 1 of the user 2 displays a portal page such that, as shown in the portal page 202 for the user 2, the portal page includes portlets which are the same portlets as those of the portal page 200 for a portal-page administrator, and some of the portlets are arranged at mutually interchanged positions.

Generally, as described above, with respect to accesses to the same portal page, the portal system is capable of controlling (changing) a screen display for each of the clients 1s (or for each of users of the clients 1s).

In addition, the above-described screen display for the client 1 of the user 1 can be realized by preventing the portal server 2 from displaying portlets on the basis of access authorities of the client 1 of the user 1 with respect to the portlets, or preventing the client 1 of the user 1 from displaying the portlets.

The screen display for the second client 1 of the user 2 can be realized by being that the client 1 of the user 2 sets layout information of the portal page.

Next, data stored by the portal server 2 to realize the above-described screen displays will be described.

As shown in FIG. 1, information stored by the portal server 2 includes the portal information (original) 27, the individual setting information 25, the encrypted portal information 24 and the user's key information 23.

The portal information (original) 27 and the user's key information 23 are used for generating the encrypted portal information 24. In addition, the portal server 2 may delete a part of or the whole of the portal information (original) 27 after it generates the encrypted portal information 24.

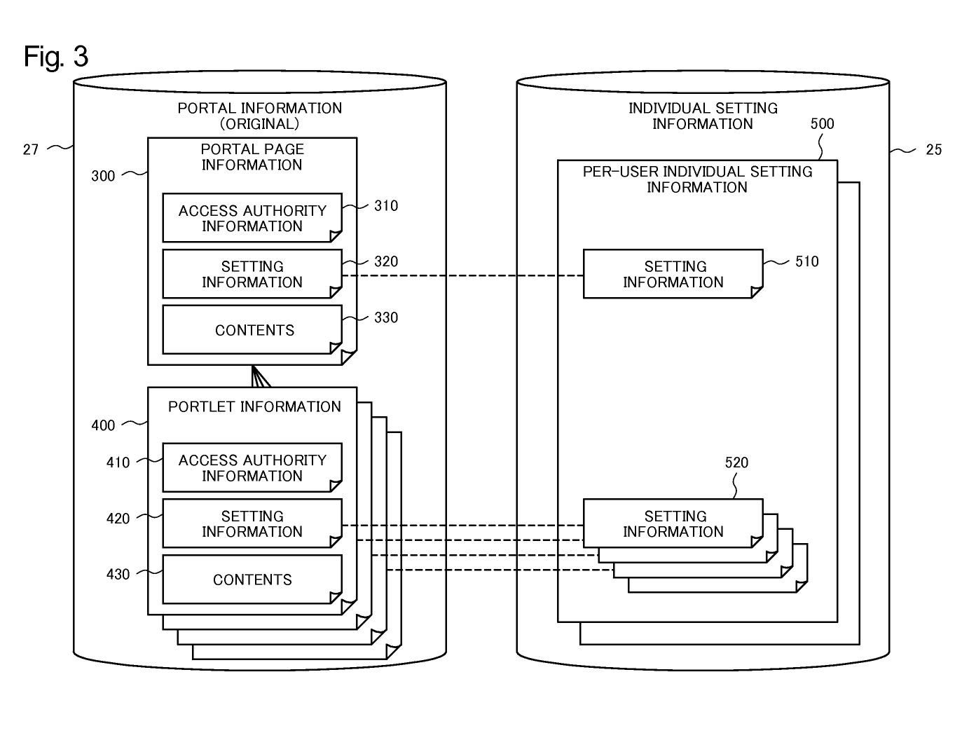

The portal information (original) 27 and the individual setting information 25 will be described in detail with reference to FIG. 3.

FIG. 3 is a diagram illustrating an example of the structure of data stored by the portal server according to this exemplary embodiment.

First, the portal information (original) 27 will be described.

The portal information (original) 27 includes portal page information 300 and portlet information 400.

The portal page information 300 is information including control data for displaying portal pages. The portal page information 300 includes access authority information 310, setting information 320 and contents 330.

In addition, the portal server 2 may store a plurality of portal page information 300. However, for convenience of description, in this exemplary embodiment, description will be made using one portal page information 300.

The portlet information 400 is information which corresponds to each of the portlets included in the portal page, and which includes control data for displaying the portlet. The portlet information 400 includes access authority information 410, setting information 420 and contents 430.

The access authority information 310 includes information specifying the permission or non-permission of an access to the portal page from the client 1. Similarly, the access authority information 410 includes information specifying the permission or non-permission of an access to the portlet from the client 1. The permission or non-permission of an access is according to the permission or non-permission display at the client 1. The above-described information which the portal server 2 sets in order to inhibit display of a part of portlets is the access authority information 410.

The setting information 320 is information which includes information for correlating the portal page with portlets included in the portal page, and which specifies the layout of the portlets and the contents 330.

The setting information 420 is information which specifies the layout of contents displayed within the portlet, methods for acquiring the contents, and the like.

The portal page information 300 and the portlet information 400 may include information different from the above-described the setting information 320, the setting information 420, the access authority information 310, the access authority information 410, the contents 330 and the contents 430, respectively.

The contents 330 and the contents 430 are information which is an object composed of texts, graphics or sounds, a script file for generating an object, or the like, and which is displayed on the portal page. In addition, the contents 330 are arranged outside the frames of portlets on a portal page.

And, contents displayed by the client 1 includes not only the contents 330 and the contents 430 stored by the portal server 2, but also information acquired from the external content server 3. Hereinafter, the information acquired from the external content server 3 will be referred to as “external contents”.

The setting information 420 of the portlet information 400 includes information as to whether or not it is necessary to acquire any contents from outside, and a method for accessing the external content server 3 in the case where it is necessary to acquire the contents. In addition, in the following description of this exemplary embodiment, any external contents are not involved as contents of a portal page. However, this is for convenience of description. The client 1 according to this exemplary embodiment may acquire the external contents.

Next, the individual setting information 25 will be described.

The individual setting information 25 is setting information which is specified by each of users (specifically, each of the clients 1s), and which is related to the layout of portal page and portlets, and the presence or absence of display with respect to each of the portlets. As shown in FIG. 3, the individual setting information 25 includes per-user individual setting information 500. The per-user individual setting information 500 stores setting information 510 corresponding to the setting information 320, and, further, setting information 520 corresponding to the setting information 420. However, there is a case where the user (the client 1) does not specify any display setting. In this case, the portal server 2 stores the setting information 320 and the setting information 420 as the setting information 510 and the setting information 520 of the per-user individual information 500. The client 1 can realize the inhibition of display of any of portlets and the layout change of portlets on the basis of the setting information 510 and the setting information 520.

In addition, in the case where the client 1 needs to present certain information (for example, user identification information) to the external content server 3 when acquiring external contents, the individual setting information 25 may store the information.

A portal server related to the present invention stores information equivalent to the described-above portal information (original) 27 and the individual setting information 25, and provides the functions of the portal system. However, the portal server 2 according to this exemplary embodiment further stores the encrypted portal information 24 and the user's key information 23.

The encrypted portal information 24 and the user's key information 23 will be described.

The portal server 2 according to this exemplary embodiment does not use the access authority information 310 included in the portal page information 300 and the access authority information 410 included in the portlet information 400. Instead, the portal server 2 according to this exemplary embodiment encrypts the portal page information and the portlet information such that a user, who is permitted to access the portal page and the portlets, can decrypt them. That is, the portal server 2 according to this exemplary embodiment encrypts the setting information 320 and the contents 330 included in the portal page information 300, and the setting information 420 and the contents 430 included in the portlet information 400. Then, the portal server 2 delivers a decryption key for encrypted information in such a way that clients is (users) which (who) are not permitted to access the encrypted information cannot use the decryption key. The portal server 2 according to this exemplary embodiment performs control using such a mechanism as described above as substitute for the control using the access authority information.

In this exemplary embodiment, the way of restricting the use of the decryption key for decrypting the encrypted portal information 24 to a user who is permitted to access the portal information 24 is not limited to a particular one. In the following description of this exemplary embodiment, it is supposed that a public key cryptosystem is employed as an example.

This public key cryptosystem is also called an asymmetric key cryptosystem, and is a cryptosystem in which, in encryption and decryption of data, two keys (a public key and a secret key) forming a pair are appropriately used. In a system employing the public key cryptosystem, data encrypted by using one key can be decrypted only by using the other key. This exemplary embodiment uses this function.

Meanwhile, a common key cryptosystem is a cryptosystem in which the same key is used for encryption and decryption. Thus, a key (a common key) in the common key cryptosystem is an encryption key in encryption, and is a decryption key in decryption. (Hereinafter, although terms such as an encryption key and a decryption key will be arbitrarily used, both are the same key (the common key).)

For example, the portal server 2 encrypts data to be transmitted to the client 1 with a common key (an encryption key). Then, the portal server 2 encrypts the “encryption key (which is a common key, and thus, is also a decryption key)” with a public key for the client 1 to which the data is transmitted. Then, the portal server 2 transmits the encrypted data and the encrypted encryption key. The client 1, which has received the encrypted data and the encrypted encryption key (decryption key), decrypts the encrypted decryption key (encryption key) with its own secret key. The client 1 can decrypt the encrypted data with the decryption key having been decrypted. However, other apparatuses, which do not have the secret key, cannot decrypt the decryption key. In this way, the portal server 2 can safely provide a predetermined client 1 with a decryption key for data by using a public key. The portal server 2 according to this exemplary embodiment provides the client 1 with a decryption key (hereinafter, also referred to as “decryption information”) by employing the public key cryptosystem and the common key cryptosystem so that the client 1 can decrypt a part of portal information, which the client 1 is permitted to access. The details of this mechanism will be described below.

In this exemplary embodiment, the client 1 stores the secret key for the client 1 (user) itself as a user side key information 118, and the portal server 2 stores the public key for the user as the user's key information 23. That is, the data which is encrypted with the user's key information 23 stored by the portal server 2 can be decrypted by the client 1 which stores the user side key information 118 corresponding to the user's key information 23.

The user's key information 23 exists individually for all users who utilize the portal page. The portal server 2 stores the user' key information 23 in advance in accordance with a request from the user or the client 1.

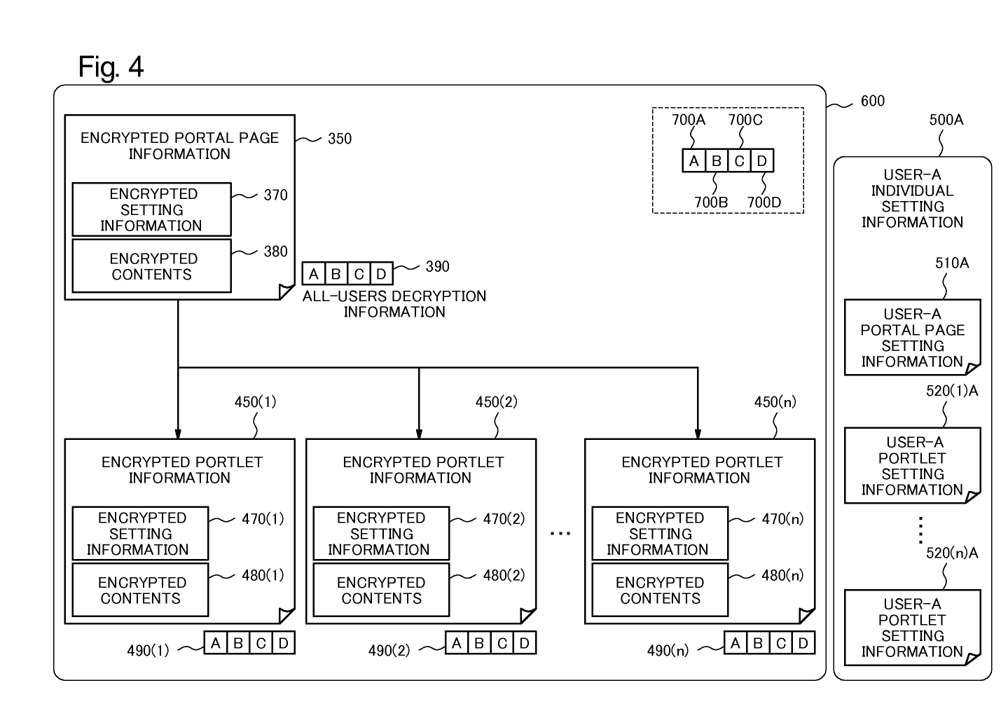

FIG. 4 is a diagram illustrating an example of the structure of data which the portal server 2 provides to the client 1.

The encrypted portal information 24 is the above-described information which is encrypted and stored in advance (encrypted portal information 600). And, as shown in FIG. 4, the encrypted portal information 600 includes encrypted portal page information 350, encrypted portlet information 450, all-users decryption information 390 and all-users decryption information 490.

The all-users decryption information 390 is information obtained by combining all user information (decryption information) encrypted the decryption key corresponding to the encrypted portal page information 350 by using the user's key information 23. Similarly, the all-users decryption information 490 is information obtained by combining all user information (decryption information) encrypted the decryption key corresponding to the encrypted portlet information 450 by using the user's key information 23.

Here, in order to make it easy to understand this description, first, the client 1 is described.

Referring to FIG. 1, the client 1 includes the browser 11.

The browser 11 accesses the portal page provided by the portal server 2 on the basis of an operation performed by the user of the client 1.

Accordingly, the browser 11 includes a portal page request transmission unit 111, a portal information reception unit 112, a portal information decryption unit 113, a content request transmission unit 114, a content request reception unit 115, a content combination unit 116, a content display unit 117 and the user side key information 118.

The user side key information 118 is stored in a data storage area of the client 1.

The portal page request transmission unit 111 generates the request to the portal page, and transmits it to the portal server 2.

The portal information reception unit 112 receives a response from the portal server 2 to the above request to the portal page. This response includes the encrypted portal information 600 and the per-user individual information 500 (user-A individual setting information 500A in FIG. 4).

The portal information decryption unit 113 decrypts the encrypted portal information 600 included in the above response.

Hereinafter, “the encrypted portal information 600” having been decrypted” will be abbreviated into just “decrypted portal information 600”. And, with respect to other information, similarly, a portion of “encrypted information” having been decrypted” will be abbreviated into just “decrypted information” after the decryption of the encrypted information.

The content request transmission unit 114 transmits a request for acquiring contents to the external content server 3 in accordance with necessity on the basis of decrypted setting information 470 and the per-user individual information 500. In addition, there is a case where the content request transmission unit 114 does not acquire contents from the external content server 3.

The content request reception unit 115 receives a response from the external content server 3 to the above request for acquiring contents.

The content combination unit 116 combines decrypted contents 380 and decrypted contents 480 which are obtained from the decrypted portal information 600 and the external contents on the basis of decrypted setting information 370, decrypted setting information 470 and the per-user individual information 500, and generates data for the portal page to be displayed on the display screen.

The content display unit 117 displays the data for the portal page, which has been generated by the content combination unit 116, on the display screen of the client 1.

The user side key information 118 is key information for decrypting the all-users decryption information 390 and the all users' decryption information 490 which are transmitted from the portal server 2.

In addition, the client 1 may realize operation of transmission/reception and screen display regarding the portal information reception unit 112, the portal information decryption unit 113, the content request transmission unit 114, the content request reception unit 115 and the content display unit 117 by using the functions of a general browser. The client 1 may obtain other functions by downloading corresponding software from the portal server 2 or other servers, and adding the obtained software into the client 1. Alternatively, the client 1 may obtain other functions by reading out corresponding programs from a storage medium which stores the programs in advance such that the programs can be read out by a computer, and installing the read-out programs into the client 1 by using a storage-medium reading apparatus.

Next, operation of this exemplary embodiment including the aforementioned components will be described in detail.

First, preconditions in this description are described here.

It is supposed that all registrations of the portal information (original) 27, the individual setting information 25 and the user's key information 23 into the portal server 2 are already completed. And, it is supposed that the functions specific to this exemplary embodiment in the client 1 are already provided in the browser 11, and the user side key information 118 is also registered in the browser 11.

And, it is supposed that, before the portal server 2 receives the request to the portal page from the browser 11, the authentication server 4 has already completed user authentication. Then, it is supposed that the client 1 has added user information, for which the user authentication is already completed, to the request. Thus, it is supposed that the portal server 2 can obtain information related to the user's identifier, attributes and the like, together with the contents of the request.

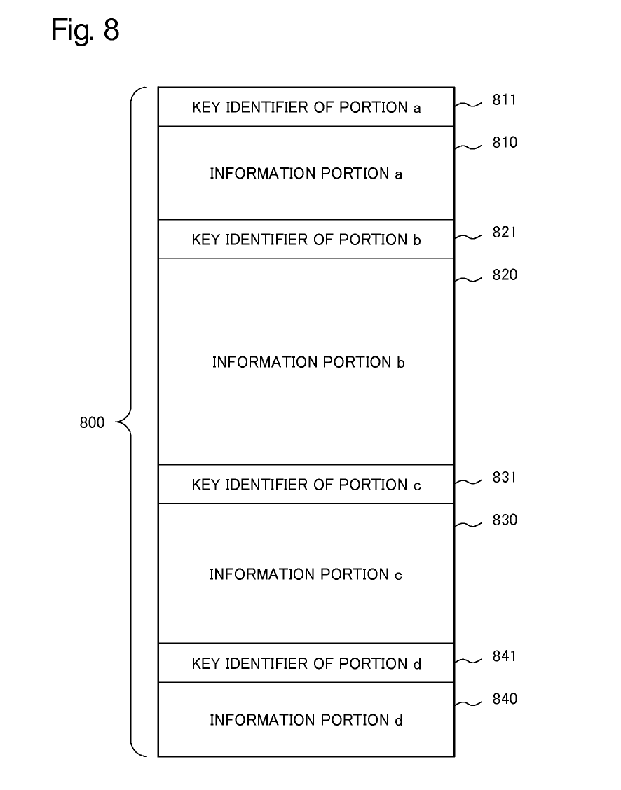

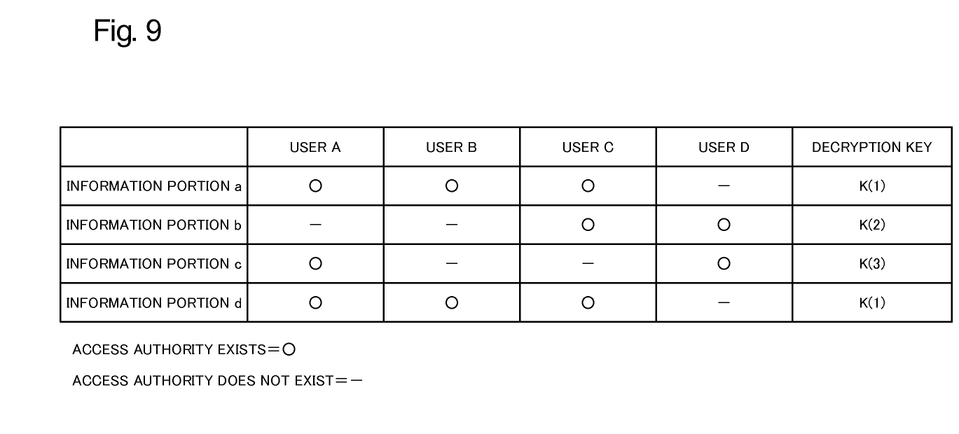

And, it is supposed that the users who can utilize the portal page are made four users A, B, C and D, and access authorities shown in FIGS. 8 and 9 are set on them.

The details of operation in this exemplary embodiment under these preconditions will be described.

The main operation of this exemplary embodiment is divided into operation of generating and updating the encrypted portal information 24, and operation which is performed at the time when the client 1 has transmitted the request to the portal page of the portal server 2. Hereinafter, the individual operations will be sequentially described.

First, the operation of generating and updating the encrypted portal information 24 will be described.

The portal server 2 according to this exemplary embodiment stores the encrypted portal information 24 in advance before receiving requests to the portal page from users. The encrypted portal information 24 is generated by using the portal information (original) 27 and the user's key information 23.

The update of the encrypted portal information 24 is carried out when the contents of any of the portal information (original) 27 and the user's key information 23 is changed. Here, the timing point of the change has occurred corresponds to, for example, a timing point when any one of the following events has occurred: an addition or a deletion of a user; a change of an access authority of an existing user; a change of a layout of a portal page or a portlet; an addition, a deletion or a change of contents; and an addition, a deletion or a change of the user's key information 23.

The portal server 2 may store the portal information (original) 27 or the user's key information 23 at a place other than the portal server 2. And, an apparatus other than the portal server 2 may generate or update the encrypted portal information 24, and the portal server 2 may receive the encrypted portal information 24 from the apparatus.

In addition, the portal server 2 may delete the portal information (original) 27 after the completion of generation of the encrypted portal information 24. In the case where the portal information (original) 27 is deleted, when updating the encrypted portal information 24, the portal server 2 decrypts a part of information necessary for the update among the encrypted portal information 24, or the whole of the encrypted portal information 24, and obtains information equivalent to the portal information (original) 27. In addition, the portal server 2 stores the decryption key used for the above-described decryption in advance in a data storage area (not illustrated) of the portal server 2.

In addition, in this exemplary embodiment, the portal server 2 generates the encrypted portal information 24 by encrypting the portal information (original) 27. However, the portal server 2 according to this exemplary embodiment may not store the portal information (original) 27. For example, the portal server 2 may acquire individual information composing the portal information (original) 27, and may generate the encrypted portal information 24 on the basis of the acquired information.

And, in the case where the portal server 2 receives the setting information related to access authorities shown in FIGS. 8 and 9 as input data from the portal administrator, the portal server 2 may not use the access authority information 310.

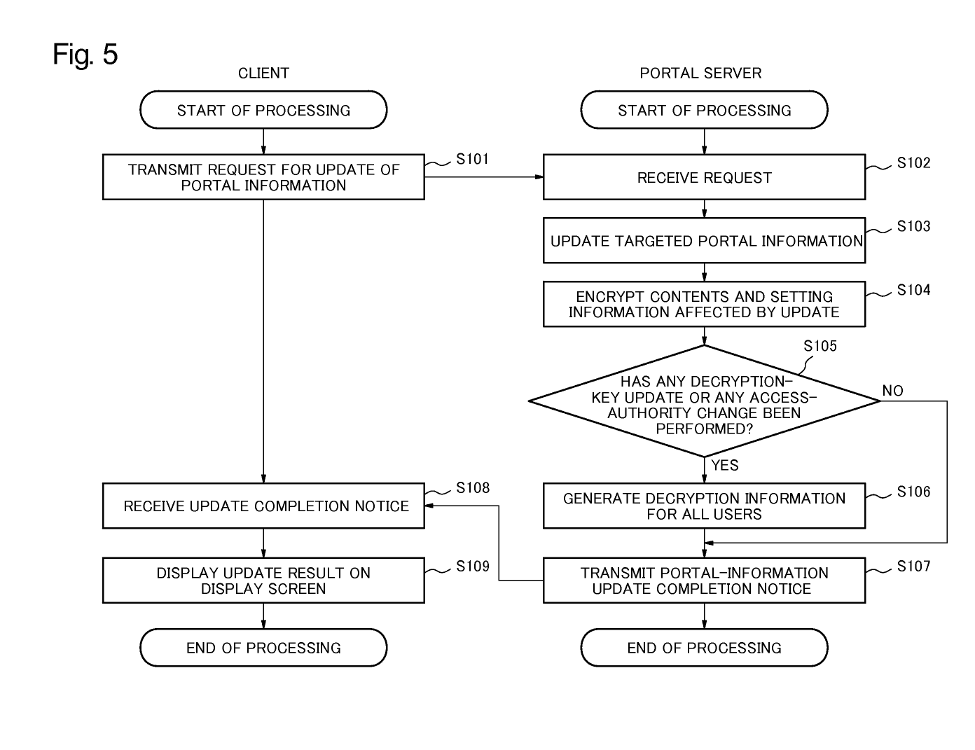

Hereinafter, the operation of generating and updating the encrypted portal information 24 will be described with reference to FIG. 5.

FIG. 5 is a flowchart illustrating an example of operation of updating the encrypted portal information 24, according to this exemplary embodiment.

In addition, hereinafter, description will be made referring to FIGS. 1 to 4 arbitrarily.

First, the client 1 requests the portal server 2 to generate or update the encrypted portal information 24 via the browser 11 or the like on the basis of operation of an administrator or the like of the portal system. In addition, the operation of the client 1 in the generation and the update of the encrypted portal information 24 can be realized by using the function of a general browser.

The client 1 detects an input operation of an update request, performed by the administrator of the portal system, to the browser 11. Then, the portal page request transmission unit 111 of the browser 11 of the client 1 transmits the update request for updating the portal information 24 to the portal server 2 (step S101). The update request includes a target for the update and the contents of the update.

The portal page request reception unit 21 of the portal server 2 receives the update request for updating the portal information 24 (step S102).

In addition, the authentication server 4 may perform user authentication between step 101 and step S102 to verify that a transmission source of the update request is the client 1 which is operated by an administrator of the portal systems.

Next, the portal information management unit 22 updates the portal information (original) 27 on the basis of the received request (step S103). In addition, in the case where there is no encrypted portal information 24, the portal information management unit 22 assumes that the entire scope of the portal information (original) 27 has been updated, and carries out processing in steps starting from step S104.

Next, the portal information management unit 22 encrypts an updated scope of the portal information (original) 27 (i.e., an updated scope of the portal page information 300 and the portlet information 400), and generates the encrypted portal page information 350 and the encrypted portlet information 450 (step S104). Here, the updated scope of the portal information (original) 27 corresponds to updated portions of the setting information 320, the setting information 420, the contents 330 and the contents 430.

In addition, even in the case where there is no direct update with respect to the above information, the user's key information 23 may need to be updated on the basis of the update of the access authority information 310 and/or that of the access authority information 410. In the case where the user's key information 23 has been updated, it is necessary to re-generate the encrypted portal page information 350 and the encrypted portlet information 450.

However, in the case of changes in the access authorities, these kinds of information may not need to be updated.

The details of operation of encryption will be described below by using a specific example.

Next, the portal information management unit 22 confirms whether or not any update in at least any one of the user's key information 23, the access authority information 310 and the access authority information 410 has occurred in steps S103 and S104 (step S105). If no update has occurred (NO in step S105), the portal information management unit 22 terminates the update of the portal information (original) 27.

If any update has occurred, the portal information management unit 22 generates the all-users decryption information 390 and the all-users decryption information 490 corresponding to a scope affected by the update (step S106). The details of this generation operation will be described below by using a specific example.

The portal information management unit 22 transmits an update completion notice for notifying the completion of update of the portal information 24 to the client 1 via the portal information transmission unit 26 (step S107).

The browser 11 of the client 11 receives the update completion notice of the portal information 24 (step S108).

Then, the browser 11 of the client 1 displays the result of update of the portal information 24 (step S109).

Next, the operation of encrypting the encrypted portal page information 350 and the encrypted portlet information 450 included in the portal server 2, and the operation of generating the all-users decryption information 390 and the all-users decryption information 490 will be described by using a specific example.

It is supposed that, according to the preconditions, users who can utilize the portal page are four users A, B, C and D, and access authorities shown in FIGS. 8 and 9 are set with respect to the portal page.

FIG. 8 is a diagram illustrating an example of the data structure of an encrypted portal page according to the first exemplary embodiment.

FIG. 9 is a diagram illustrating an example of relations among users using the clients 1s, access authorities and decryption keys, according to the first exemplary embodiment.

As described above, even when the clients is of the portal system access the same portal page, the clients is display mutually different views. Here, it is supposed that portal page information is divided into information portions a, b, c and d as shown in FIG. 8.

Under the settings of the access authorities shown in FIG. 9, when the client 1 of the user A accesses the portal page, a portal server related to the present invention selects information portions a, c and d, and sends back them to the client 1 of the user A. And, when the client 1 of the user C accesses the portal page, the portal server related to the present invention selects information portions a, b and d, and sends back them to the client 1 of the user C. When the client 1 of each of the users B and D accesses the portal page, the portal server related to the present invention performs operation in a way similar to that described above.

Here, in order to concretize an image, examples of the information portions a, b, c and d are given. Each of the information portions a and d which are used by both of the users A and C is, for example, a common menu among staff members or a notification document to staff members. The information portion c which is referred to by the user A is, for example, a business menu for bosses. The information portion b which is referred to by the user C is, for example, a business menu for general staff members. That is, the information portions of portal page information do not mean just portions resulting from division of a portal-page display screen, but, variation of adjustment for user type about information which are displayed with in the same area of the portal page. The information portions of portal page information include information which is not displayed simultaneously. And, the information portion includes the setting information 320, such as information related to layouts.

In this specific example, it is supposed that the four information portions a, b, c and d are enough to obtain data necessary for generating portal page information for all the users. The encrypted portal page information 350 in this specific example is information which is encrypted individual data necessary for generating portal page information for all users, and combined the encrypted data (refer to FIG. 8).

The portal server 2 according to this exemplary embodiment may use mutually different encryption keys in the encryption of the respective information portions. And, the portal server 2 may use the same encryption key in the encryption of the information portions in which combinations of users who are given access authorities are the same, as a unit of encryption.

For example, referring to FIG. 9, for each of the information portions a and d, access authorities are given to users A, B and C. Thus, the portal server 2 uses the same encryption key (a decryption key K(1)) to the information portions a and d.

For the information portions b and c, combinations of users who are given access authorities are different from each other. Thus, the portal server 2 uses different encryption keys (decryption keys K(2) and K(3)) to the information portions b and c, respectively.

Then, for the user A, the portal server 2 encrypts the decryption keys K(1) and K(3) with the public key of the user A. And, for the user B, the portal server 2 encrypts the decryption key K(1) with the public key of the user B. And, for the user C, the portal server 2 encrypts the decryption keys K(1) and K(2) with the public key of the user C. And, for the user D, the portal server 2 encrypts the decryption keys K(2) and K(3) with the public key of the user D. Then, the portal server 2 combines the encrypted decryption keys, and generates the decryption information. The portal server 2 transmits the decryption information to the clients 1s of all the users. The client 1 of each of the users decrypts the decryption information with its own secret key. For example, the client 1 of the user A can decrypt the decryption keys K(1) and K(3). Thus, the client 1 of the user A can decrypt the information portions a, c and d. In this way, the portal server 2 can realize access authority settings on the information portions of the portal page, shown in FIG. 9.

In addition, the four information portions form just an example. The portal server 2 according to this exemplary embodiment may generate less than four information portions, and may generate more than four information portions.

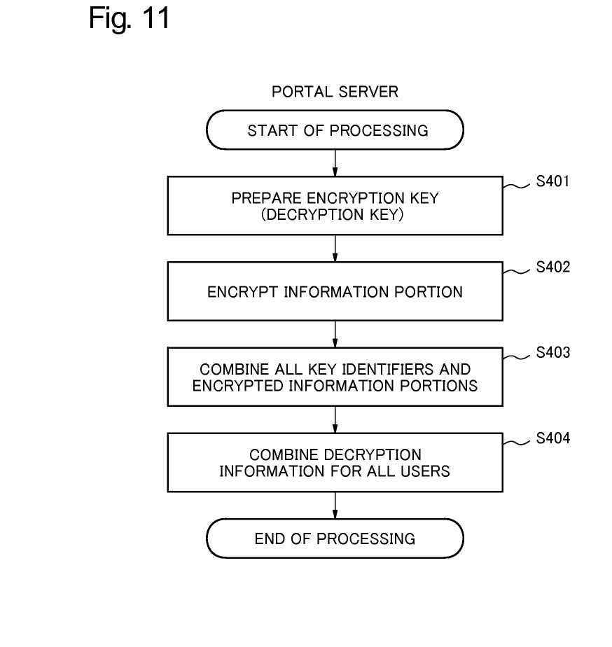

Hereinafter, the details of operation of encryption will be described with reference to FIG. 11.

FIG. 11 is a flowchart illustrating an example of operation of encryption processing of the portal page information, according to the first exemplary embodiment.

First, the portal information management unit 22 determines a unit of encryption on the basis of the access authority information 310 of the portal page information 300 or setting information (such as shown in FIG. 9) as substitute for the access authority information 310, and prepares the required number of encryption keys (decryption keys). For example, in the case of access authorities shown in FIG. 9, the portal information management unit 22 prepares three encryption keys (decryption keys) consisting of K(1) to K(3) (step S401). The portal information management unit 22 may generate encryption keys (decryption keys), or may store and use encryption keys (decryption keys) generated in advance.

Next, the portal information management unit 22 generates the information portions a, b, c and d from a portion of the portal page information 300, which results from removing the access authority information 310 from the portal page information 300. Then, the portal information management unit 22 encrypts each of the information portions a, b, c and d with the encryption keys (K(1)-K(3)), and generates an encrypted information portion a 810, an encrypted information portion b 820, an encrypted information portion c 830 and an encrypted information portion d 840 (step S402). The portal information management unit 22 may combine portions which are encrypted with the same encryption key, that is, the encrypted information portion a 810 and the encrypted information portion d 840, into one information portion.

Next, the portal information management unit 22 gives key identifiers to the decryption keys K(1)-K(3), and combines all the information portions such that the key identifier of the each information portion and its encrypted information portion are formed to a pair. That is, the portal information management unit 22 makes a key identifier of portion a 811 and the encrypted information portion a 810 into a pair and combines them. Then, the portal information management unit 22 subsequently makes a key identifier of portion b 821 and the encrypted information portion b 820 into a pair and combines them. Afterwards, the portal information management unit 22 similarly combines until the completion of combination of the information part d. In this way, the portal information management unit 22 generates the encrypted portal page information 800 (step S403). Here, the key identifier of a decryption key is information which is unique within a scope covering a portal page and portlets included in the portal page. The key identifier of a decryption key is not limited to a particular one. For example, the key identifier of a decryption key may be also a string of characters having an arbitrary number of characters.

Next, the portal information management unit 22 makes, for each of users, copy of the decryption keys in accordance with the access authorities and the above-described key identifiers into a pair on the basis of the access authority information 310 of the portal page information 300 or setting information (such as shown in FIG. 9) as substitute for the access authority information 310, and combines them. For example, the portal information management unit 22 combines, for the user A, a copy of the decryption key K(1) with the key identifier of portion a 811 to which the decryption key K(1) is given, and further combines a copy of the decryption key K(3) with the key identifier of portion c 831 to which the decryption key K(3) is given and a copy of the decryption key K(1) with the key identifier of portion d 841 to which the decryption key K(3) is given. The result of this processing for combining the copies of the decryption keys with the identifiers is decryption information 700A for the user A corresponding to the encrypted portal page information 350 shown in FIG. 4. Similarly, the portal information management unit 22 also generates decryption information 700B to 700D for the users B to D, and obtains the all-users decryption information 390 by combining the decryption information 700A to 700D (step S404).

With the above processes, the encryption processing to the portal page information 300 of the portal information management unit 22 has been completed.

Similarly, the portal information management unit 22 also repeats the encryption processing in steps S401 to S404 on each of the portlet information 400, and generates the encrypted portal information 600.

There is a case where there is no access authority to the portlet information for the user. In this case, there is not decryption information for user who does not have any access authority for the portlet information. Accordingly, in this case, the portal information management unit 22 does not need to generate any decryption information for the user. However, in order not to cause other users to find that the user does not have any access authority for the portlet information, the portal information management unit 22 may provide dummy decryption information. This dummy decryption information is information which can not be decrypted normally. The portal information decryption unit 113 of the client 1 can determine that the client 1 does not have any access authority on the basis of that the decryption information cannot be decrypted.

In the description so far, the portal server 2 uses a common key cryptosystem (a symmetric key cryptosystem) as a cryptosystem for portal page information and portlet information. However, the portal server 2 according to this exemplary embodiment may use a public key cryptosystem (an asymmetric key cryptosystem). In the case where a public key cryptosystem is used, the portal server 2 should encrypt the portal page information and the portlet information with one of keys forming a pair, and should encrypt and deliver the other key of the pair.

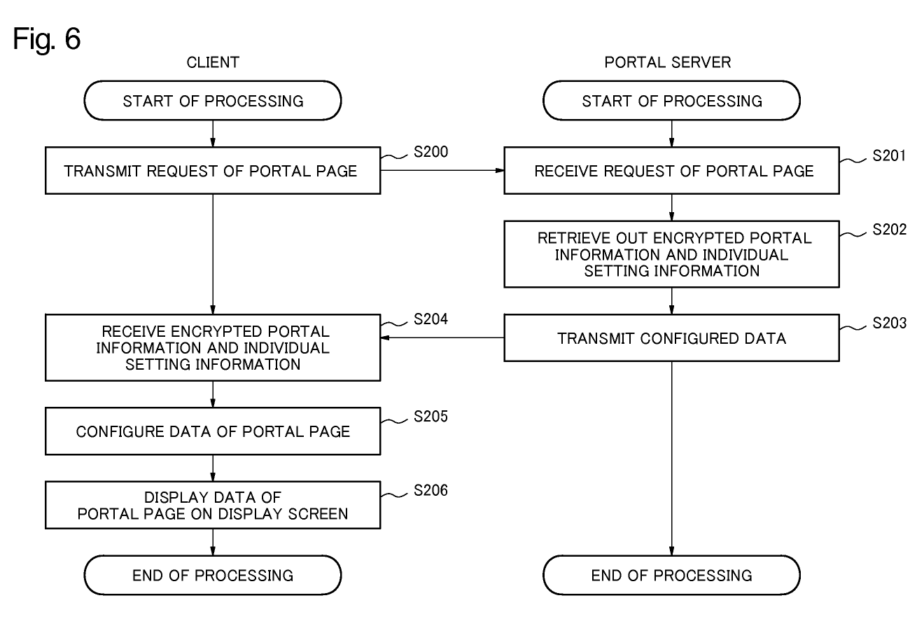

Next, operation performed when the client 1 of the client 1 transmits a request of the portal page to the portal server 2 will be described with reference to FIG. 6.

FIG. 6 is a flowchart illustrating an example of operation of request processing to the portal page according to the first exemplary embodiment.

When the user A operates the browser 11 of the client 1 in order to display the portal page, the browser 11 of the client 1 detects the operation. Then, the portal page request transmission unit 111 of the browser 11 transmits a request of the portal page to the portal server 2 (step S200).

In addition, although not illustrated, the authentication server 4 performs user authentication. Thus, the request from the client 1 includes identification information related to the user A.

The portal page request reception unit 21 of the portal server 2 receives the request of the portal page (step S201).

Next, the portal information management unit 22 recognizes that the received request is a request from the client 1 of the user A on the basis of user identification information obtained from the received request, and retrieves user-A individual setting information 500A corresponding to the portal page which is a request target, from the individual setting information 25. Then, the portal information management unit 22 retrieves the encrypted portal information 600 corresponding to the portal page which is a request target, from the encrypted portal information 24 (step S202). Then, the portal information management unit 22 configures data on the basis of the encrypted portal information 600 and the user-A individual setting information 500A, and transmits the resultant data to the client 1.

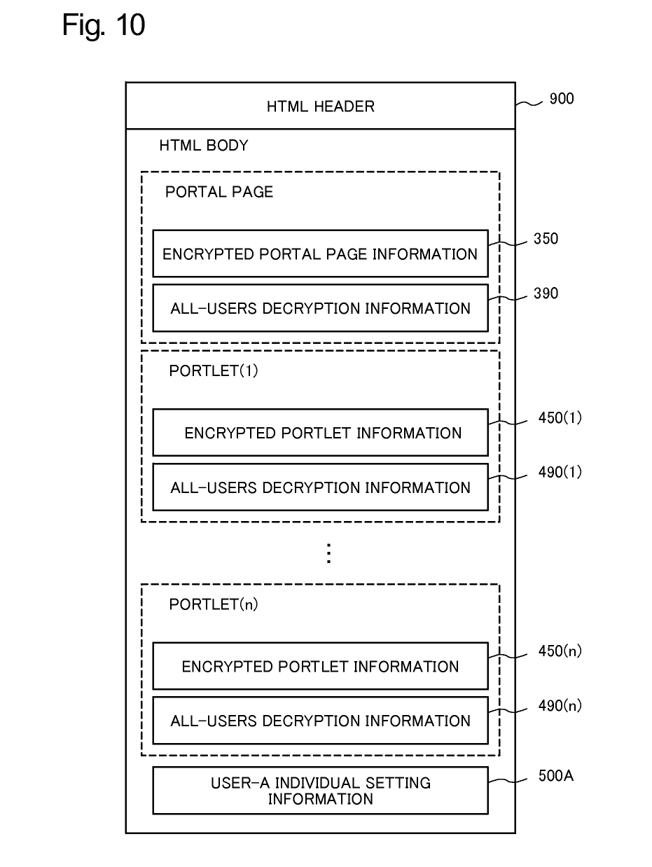

FIG. 10 is a diagram illustrating an example of information 900 which is transmitted to the client 1, according to this exemplary embodiment.

The portal information management unit 22 transmits the information 900, which is to be transmitted to the client 1, to the client 1 via the portal information transmission unit 26 (step S203). The portal server 2 terminates the processing on the received request of the portal page.

In this way, the portal server 2 does not determine which information of the encrypted portal information 600 the user A can decrypt. The portal server 2 also performs combination processing on portal information in advance. The portal server 2 transmits information which has been already generated.

That is, the portal server 2 according to this exemplary embodiment should merely transmit generated information as a response to an access from the client 1, and does not need to perform processing for determination of an access authority, and the like. In this way, the portal server 2 according to this exemplary embodiment can reduce a processing load on itself.

The portal information reception unit 112 of the client 1 receives the information 900, that is, the encrypted portal information 600 and the user-A individual information 500A, transmitted to the client 1 (step S204).

Then, the client 1 configures data for the portal page by using the received information (step S205). The detailed of this operation will be described below.

The content display unit 117 displays the data for the portal page on a display screen of the client 1 (step S206).

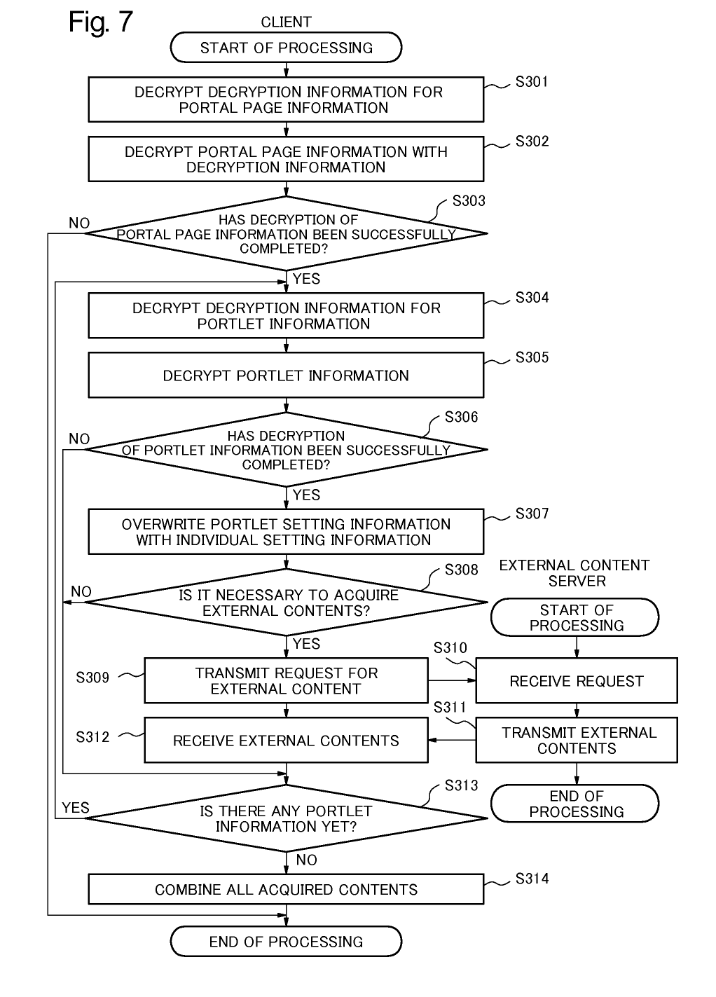

Hereinafter, the operation in step S205, where the client 1 configures data for the portal page from the received information, will be described in detail with reference to FIG. 7.

FIG. 7 is a flowchart illustrating an example of operation of data configuration processing of portal information performed by the client 1, according to the first exemplary embodiment.

First, the portal information decryption unit 113 decrypts the all-users decryption information 390 corresponding to the encrypted portal page information 350 among the encrypted portal information 600 by using the user side key information 118 (for example, a secret key). That is, the portal information decryption unit 113 extracts the user-A decryption information 700A among the all-users decryption information 390 (step S301).

A method for the portal information decryption unit 113 to extract the user-A decryption information 700A is not limited to a particular one. For example, the portal information decryption unit 113 may sequentially decrypt the all-users decryption information 390 from the beginning, and may determine decryption information which has been successfully decrypted into information of a correct decryption-information format as the user-A decryption information 700A. Alternatively, in the case where information for identifying which portion of the all-users decryption information 390 corresponds to which one of the users is added to the all-users decryption information 390, the portal information decryption unit 113 may search the location of information for decryption of the user-A on the basis of the identification information, and may decrypt it. The method for the portal information decryption unit 113 to extract depends on the generation and update method for the encrypted portal information 24 in the portal server 2.

In the case where the access authorities shown in FIG. 9 are set, the portal information decryption unit 113 succeeds in decryption of the user-A decryption information 700A. The user-A decryption information 700A includes the decode key K(1) corresponding to the key identifier of portion a 811 and the key identifier of portion d 841, and the decode key K(3) corresponding to the key identifier of portion c 831. And, the user-A decryption information 700A does not include the decryption key K(2) corresponding to the key identifier of portion b 821.

When the user-A decryption information 700A has been obtained, the portal information decryption unit 113 decrypts the encrypted portal page information 350 by using the user-A decryption information 700A (step S302). That is, the portal information decryption unit 113 checks key identifiers included in the encrypted portal page information 800 shown in FIG. 8, finds out the encrypted information portion a 810 corresponding to the key identifier of portion a 811, and decrypts it with the decryption key K(1). Similarly, the portal information decryption unit 113 finds out the encrypted information portion c 830 on the basis of the key identifier of portion c 831, and finds out the encrypted information portion d 840 on the basis of the key identifier of portion d 841. Then, the portal information decryption unit 113 decrypts the encrypted information portions with the corresponding decryption keys obtained from the user-A decryption information 700A. In this way, the portal information decryption unit 113 obtains information which is decrypted portion which is permitted to be accessed by the user of the relevant client 1 in the encrypted portal page information 350. In this specific example, the portal information decryption unit 113 obtains the information portion a, the information portion c and the information portion d which are permitted to be accessed by the user A.

The portal information decryption unit 113 determines whether or not the encrypted portal page information 350 has been correctly decrypted (step S303).

In the case where the user-A decryption information 700A is not correctly obtained in step S301, or the encrypted portal page information 350 is not correctly decrypted in step S302 (NO in step S303), the client 1 determines that the access to the portal page is not permitted, and displays this effect on a display screen of the browser 11, and terminates this processing.

If the encrypted portal page information 350 is correctly decrypted (YES in step S303), the portal information decryption unit 113 decrypts the all-users decryption information 490 (1) corresponding to the encrypted portlet information 450 (1), among the encrypted portal information 600, by using the user side key information 118 (step S304). A method for the decryption in step S304 is similar to that in step S301. As the result of this decryption processing, the portal information decryption unit 113 obtains a decryption key for the encrypted portlet information 450 (1).

Next, the portal information decryption unit 113 decrypts the encrypted portlet information 450 (1) by using the decryption key obtained in step S304 (step S305). A method for the decryption in step S305 is also similar to that in step S302. As the result of this decryption processing, the portal information decryption unit 113 obtains an information portion which is permitted to be accessed in the encrypted portlet information 450.

Then, the portal information decryption unit 113 determines whether or not the decryption is correctly performed in each of steps S304 and S305 (step S306).

If the decryption is not correctly performed in step S304 or step S305 (NO in step S306), the portal information decryption unit 113 determines that any access to the portlet is not permitted, and proceeds to the process (step S313) for determining whether or not next encrypted portlet information 450 exists.

If the encrypted portlet information 450 is correctly decrypted (YES in step S306), the portal information decryption unit 113 overwrites the decrypted setting information 470 included in the decrypted portlet information 450 with information included in the user-A individual information 500A for reflecting the settings for the client 1 (step S307). In addition, as described above, the user-A individual information 500A is not encrypted, and thus, does not need to be decrypted.

The portal information decryption unit 113 determines whether or not, for this portlet, it is necessary to acquire external contents from the external content server 3, on the basis of the decrypted setting information 470 which is overwritten with the user-A individual information 500A (step S308).

If it is unnecessary to acquire the external contents (NO in step S308), the portal information decryption unit 113 proceeds to the process (step S313) for determining whether or not next portlet information 450 exists.

If it is necessary to acquire the external contents (YES in step S308), the portal information decryption unit 113 generates a request for external contents to be transmitted to the external content server 3 on the basis of the decrypted setting information 470 overwritten with the user-A individual information 500A. Then, the content request transmission unit 114 transmits the request to the external content server 3 (step S309).

When receiving the request for external contents from the client 1 (step S310), the external content server 3 generates external contents for the user A, and transmits them to the client 1 (step S311).

The content request reception unit 115 of the client 1 receives the external contents transmitted from the external content server 3 (step S312).

Then, the portal information decryption unit 113 determines whether or not there exists any encrypted portlet information 450 which has not yet been processed (step S313).

If there exists any encrypted portlet information 450 which has not yet been processed (YES in step S313), the portal information decryption unit 113 returns the decryption process of the portlet information (step S304).

The portal information decryption unit 113 repeats the process from step S304 to step S313 until it processes all the encrypted portlet information 450.

In this way, the portal information decryption unit 113 acquires portlet information included in portions the user A can access and necessary external contents.

In addition, in this specific example, the portal information decryption unit 113 also attempts to decrypt encrypted portlet information 450, which is not permitted to be accessed, among the encrypted portal information 600.

However, the portal information decryption unit 113 may select the encrypted portlet information 450 which are permitted to be accessed and perform decryption processing on them. For example, the portal server 2 may provide identifiers in the encrypted portlet information 450, and may specify the identifiers of the encrypted portlet information 450 which are permitted to be accessed, in the encrypted setting information 370 of the encrypted portal page information 350.

After the decryption processing on all the decrypted portlet information 450 (NO in step S313), the content combination unit 116 configures a portal page to be displayed by combining the decrypted portal page information 350, the decrypted portlet information 450 and the external contents.

First, the content combination unit 116 overwrites the decrypted setting information 370, which is included in the decrypted portal page information 350, with the user-A individual information 500A, and retrieves layout settings of the entire portal page. Then, the content combination unit 116 arranges the decrypted contents 380 of the portal page and the frames of the portlets which is successfully decrypted on the basis of the layout settings. Then, the content combination unit 116 overwrites the decrypted setting information 470 included in the decrypted portlet information 450 with the user-A individual information 500A. Then, the content combination unit 116 retrieves layout settings for the inside of the portlet frame, and arranges the decrypted contents 480 for the portlet and the external contents for the portlet inside the portlet frame (step S314). However, there is a case where the external contents do not exist.

The content display unit 117 displays the portal pages, which is configured by the content combination unit 116, on the display unit of the client 1.

In this way, the portal server 2 according to this exemplary embodiment should merely transmit the encrypted portal information 600 generated in advance and the per-user individual setting information 500 to the client 1 which transmits the request to the portal server 2. In this way, the portal server 2 according to this exemplary embodiment can reduce a processing load on itself at the time when the portal server accesses.

And, the client 1 decrypts information of portions which are included in the encrypted portal information 600 that is transmitted to all the clients 1s and which are permitted to be accessed by the client 1 itself, combines decrypted information according to the per-user individual setting information 500 for each use, and displays. In this way, the client 1 according to this exemplary embodiment can display the portal page just like in the case of an access to a portal server related to the present invention.

That is, the portal server 2 according to this exemplary embodiment can perform in advance the process for determining the access authority of the user and the process for collecting information necessary for the user. In the other hand, a portal server related to the present invention performs these processes when it receives a request from the client. (The portal server 2 can perform such processes when generating or updating the encrypted portal information 600.) Thus, the process performed by the portal server 2 at the time when the portal server 2 receives a request from the client 1 is just the process for sending back encrypted information to the client 1. Thus, the portal server 2 according to this exemplary embodiment can realize reduction of resource consumption and a processing load. In particular, in the case where lots of users simultaneously transmit requests of portal pages to the portal server 2, and/or in the case where there exist lots of portlets included in the portal pages, in the portal server 2 according to this exemplary embodiment, the advantageous effects of suppressing the reduction of processing power and the lowering of response speed increase to a greater degree.

And, if the portal server 2 deletes the portal information (original) 27 after encryption, the information stored by the portal server 2 is the encrypted portal information 600. Accordingly, according to the portal server 2 of this exemplary embodiment, it is possible to obtain the advantageous effect of improving the safety of communication between a portal server and each of clients, and the advantageous effect of improving the safety against illegal accesses to the portal server.

And, the portal server 2 may give an expiration date of a key to each of the user's key information 23. And, the portal server 2 may give a period, during which decryption can be performed, to the encrypted portal information 24, the encrypted portal page information 350 or the encrypted portlet information 450. Through these time managements, the portal server 2 can manage display available periods at each client 1 with respect to portal pages and portlets. In addition, the portal server 2 may give an expiration date of a key and a display available period to portal pages to clients 1s included within a predetermined scope, portal pages included in a predetermined scope, and/or portlets included in a predetermined scope.

And, this exemplary embodiment uses a public-key cryptosystem as a cryptosystem. However, a cryptosystem used in this exemplary embodiment is not limited to this.

As described above, according to this exemplary embodiment, it is possible to obtain an advantageous effect of reducing the processing load on the portal server 2 at the time when the portal server 2 is accessed by each of the clients 1s.

A reason of this is as follows.

The portal server 2 according to this exemplary embodiment encrypts information necessary for all process for determining an access authority and combining contents with respect to all users in advance, in the form which enables each of the clients is to retrieve a portion which the client 1 is permitted to access. Then, in response to an access from the client 1, the portal server 2 provides the client 1 with encrypted information.

Then, the client 1 decrypts and displays a portion which is among the information received from the portal server 2, and which is permitted to be accessed by the client 1.

### Second Exemplary Embodiment

Next, a second exemplary embodiment based on the first exemplary embodiment described above will be described.

Hereinafter, description will be made focusing on characteristic portions according to this exemplary embodiment. Components which are the same as those of the first exemplary embodiment are denoted by the same reference signs as those of the first exemplary embodiment, and duplicated description on such components will be appropriately omitted.

This exemplary embodiment is different from the first exemplary embodiment in the respect that cache information related to external contents is included in the information of the encrypted portal information 24.

Here, the cache information related to external contents is a part of or the whole of the external contents which the client 1 acquires from the external content server 3. The portal server 2 according to this exemplary embodiment acquires (caches) a part of or the whole of the external contents, and incorporates them into the encrypted portal information 24 in advance. That is, the cache information related to external contents is included in the information 900 which is transmitted to the client 1 by the portal server 2. The client 1 does not acquire the external contents from the external content server 3, but can acquire the external contents, together with other portal information, from the portal server 2. This exemplary embodiment is different from the first exemplary embodiment in this point.

A system configuration of this exemplary embodiment is the same as that of the first exemplary embodiment (refer to FIG. 1). However, as described above, in encrypted portal information 601 according to this exemplary embodiment, there is a difference in the data structure of the encrypted portal information 24.

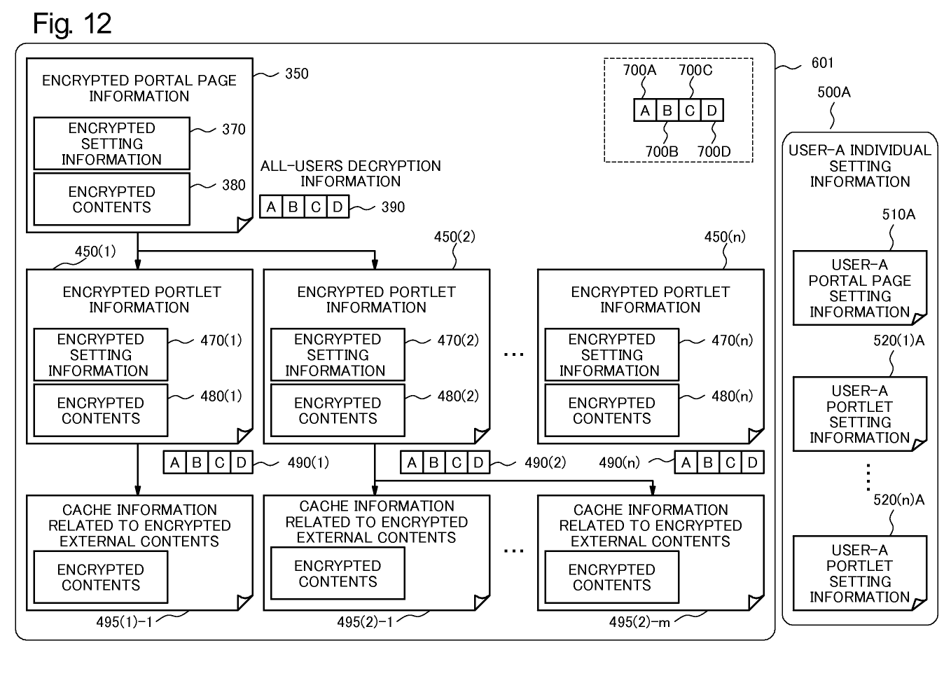

FIG. 12 is a diagram illustrating an example of the structure of data which is provided to the client apparatus, according to this second exemplary embodiment.

The encrypted portal information 601 according to this exemplary embodiment includes cache information related to encrypted external contents 495 correlated with the encrypted portlet information 450 included in the encrypted portal information 600 shown in FIG. 4.

The encrypted external contents according to this exemplary embodiment do not include information equivalent to the access authority information 310 of the portal page information 300 and information equivalent to the setting information 320 of the portal page information 300. Further, the encrypted external contents according to this exemplary embodiment do not include information equivalent to the access authority information 410 of the portlet information 400 and information equivalent to the setting information 420 of the portal page information 400. Accordingly, the cache information related to encrypted external contents 495 includes encrypted external contents.

And, the external contents do not have any independent access authority information. Thus, the portal server 2 applies the access authority information 410 related to portlets to the external contents. Therefore, a method of encrypting the cache information related to encrypted external contents 495 is the same as that of the encrypted portlet information 450. That is, the all-users decryption information 490, which is correlated with the encrypted portlet information 450, is applied to the cache information related to encrypted external contents 495. The portal server 2 does not provide any decryption information for the cache information related to encrypted external contents 495.

In addition, the number of the cache information related to encrypted external contents 495, which are correlated with the encrypted portlet information 450, is determined on the basis of the setting information 420 included in the portlet information 400.

And, there is a case where, when taking into consideration an update frequency and/or an access authority control method employed by the external content server 3, the external contents are not suited for caches. Thus, the cache information related to encrypted external contents 495 may be a part of the external contents. And, the encrypted portal information 601 may not need to include the cache information related to encrypted external contents 495.

The configuration of the web system according to this exemplary embodiment is different from that of the first exemplary embodiment in the respect that the portal server 2 acquires the external contents from the external content server 3.

The portal information transmission unit 26 according to this exemplary embodiment transmits a request for contents to the external content server 3, in addition to the operation of the first exemplary embodiment.

The portal page request reception unit 21 according to this exemplary embodiment receives the external contents from the external content server 3, in addition to the operation of the first exemplary embodiment.

The portal information management unit 22 according to this exemplary embodiment determines which ones of the external contents are to be acquired, in addition to the operation of the first exemplary embodiment. Then, when acquiring the external contents, the portal information management unit 22 generates a request for contents to be transmitted to the external content server 3. And, after receiving the external contents, the portal information management unit 22 generates the cache information related to encrypted external contents 495 from information of the received external contents, and incorporates the cache information related to encrypted external contents 495 into the encrypted portal information 24. Further, in response to the request to the portal page from the client 1, the portal information management unit 22 builds data to be transmitted to the client 1 including the cache information related to encrypted external contents 495.

Next, operation of this exemplary embodiment including the aforementioned components will be described in detail.

Preconditions in this description are ones described blow, besides preconditions the same as those of the first exemplary embodiment.

Information regarding which pieces of the external contents are to be cached, and regarding when cache information is to be acquired (updated), are determined in advance. Then, information related to cache is already given to the portal information management unit 22. The method of giving the information related to cache to the portal information management unit 22 is not limited to a particular one. For example, the portal information management unit 22 may read in a setting file in advance.

The details of operation of this exemplary embodiment under these preconditions will be described.

First, the operation of generation and update of the encrypted portal information 24 in this exemplary embodiment will be described with reference to FIG. 5.

Processes in steps S101 to S102 are the same as those of the first exemplary embodiment, and thus, description is omitted here.

In step 103, the portal information management unit 22 updates the portal information (original) 27 on the basis of the contents of the received request. In the case where there exist external contents, each being determined as a cache target described in the preconditions, among external contents which are written in the setting information 420 of the portlet information 400 falling within an update scope, the portal information management unit 22 acquires the external contents from the external content server 3. That is, the portal information management unit 22 transmits a request for contents to the external content server 3 via the portal information transmission unit 26 in accordance with a method written in the setting information 420. Then, the portal information management unit 22 receives the external contents from the external content server 3 via the portal page request reception unit 21, and stores them into a data storage area (not illustrated) of the portal server 2 (step S103).

In addition, the operation of the external content server 3 in step 103 of this exemplary embodiment is the same as the operation, which has been described in steps S310 to S311 of the first exemplary embodiment by using FIG. 7, and which is related to the processing on a request for the external contents from the client 1, and thus, description thereof is omitted here.

Next, the portal information management unit 22 encrypts the portal page information 300 and the portlet information 400 which fall within a scope in which changes has occurred in the update of the portal information (original) 27, and generates the encrypted portal page information 350 and the encrypted portlet information 450, just like in the case of the first exemplary embodiment. At this time, the portal information management unit 22 encrypts information of the external contents received in step S103 with the encryption key which is used for encryption of the portlet information 400, and generates the cache information related to encrypted external contents 495 (step S104).

Then, the portal information management unit 22 handles the cache information related to encrypted external contents 495 as a part of the encrypted portlet information 450, and finally, generates the encrypted portal information 601 shown in FIG. 12.

In addition, in the case where a timing point, which is prescribed in the preconditions and at which cache information related to external contents is to be acquired (updated), is set, the portal information management unit 22 carries out processes in steps starting from step S103 at the set timing point. However, the update performed by the portal information management unit 22 in this case targets the external contents. Other information is not updated. Thus, the portal information management unit 22 may perform only processes related to cache information regarding external contents in steps S103 and S104.

Next, operation when the user A transmits a request regarding a portal page in this exemplary embodiment will be described with reference to FIGS. 6 and 7.

Operation in steps from S200 and S201 is the same as those of the first exemplary embodiment, and thus, description thereof is omitted here.

In step S202, the portal information management unit 22 performs the same processing as that in the first exemplary embodiment, except for replacing the encrypted portal information 600 by the encrypted portal information 601. That is, the portal information management unit 22 involves the cache information related to encrypted external contents 495 in configuring data to be transmitted to the client 1 (step S202).

After this operation, operation in steps S203 to S206 of this exemplary embodiment is the same as that of the first exemplary embodiment except for a part of the details of operation in step S205 in which data of the portal page is configured from received information.

Hereinafter, the details of operation in step S205, in which data of the portal page is configured from received information, will be described with reference to FIG. 7.

Operation in steps S301 to S307 is the same as that of the first exemplary embodiment, and thus, description thereof is omitted here.

In step S308, first, the portal information decryption unit 113 of the client 1 decrypts the cache information related to encrypted external contents 495 which is correlated with the encrypted portlet information 450 which is currently processed. The portal information decryption unit 113 uses a decryption key obtained in step S304 in decryption of the encrypted cache information related to external contents 495.

However, in the case where there does not exist any encrypted cache information related to external contents 495, the portal information decryption unit 113 does not execute this operation, but performs subsequent operation.

Afterwards, the portal information decryption unit 113 performs the same processing as that is performed in the first exemplary embodiment. That is, the portal information decryption unit 113 analyzes the decrypted setting information 470 which is overwritten with the user-A individual information 500A, investigates information related to contents included in this portlet, and determines whether or not it is necessary to acquire external contents from the external content server 3. At this time, the portal information decryption unit 113 takes the decrypted cache information related to external contents 495 into consideration of the determination. Then, if it is unnecessary to acquire external contents other than the decrypted cache information related to external contents 495 from the external content server 3, the portal information decryption unit 113 determines that it is unnecessary to acquire external contents (step S308). That is, in the case where there exists the decrypted cache information related to external contents 495, the client 1 according to this exemplary embodiment can omit at least a part of the processing in steps S309 to S312.

After this operation, the client 1 handles the decrypted cache information related to external contents 495 in the same manner as that for the external contents acquired in steps S309 to S312. Then, the client 1 displays the decrypted cache information related to external contents 495 on a display screen of the browser 11 as part of the portal page configured by the content combination unit 116.

As described above, this exemplary embodiment has an advantageous effect of enabling reduction of a processing load on each of the client 1 and the external content server 3 at the time when the client 1 accesses the portal page, in addition to the same advantageous effects as those described above in the first exemplary embodiment.

A reason of this is that the portal server 2 according to this exemplary embodiment acquires external contents from the external content server 3, and caches them in advance; and, in response to an access to a portal page from the client 1, the portal server 2 according to this exemplary embodiment can provide the client 1 with cache information related to the external contents which has been cached in advance.

### Third Exemplary Embodiment

In addition, configurations of exemplary embodiments according to the present invention are not limited to the configurations of the first and second exemplary embodiments.

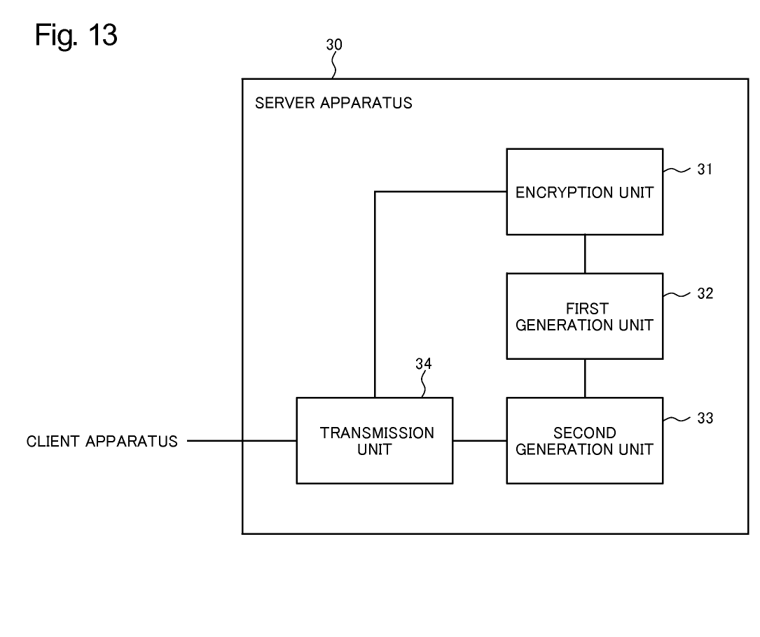

FIG. 13 is a block diagram illustrating an example of the configuration of a server apparatus 30 according to this third exemplary embodiment.

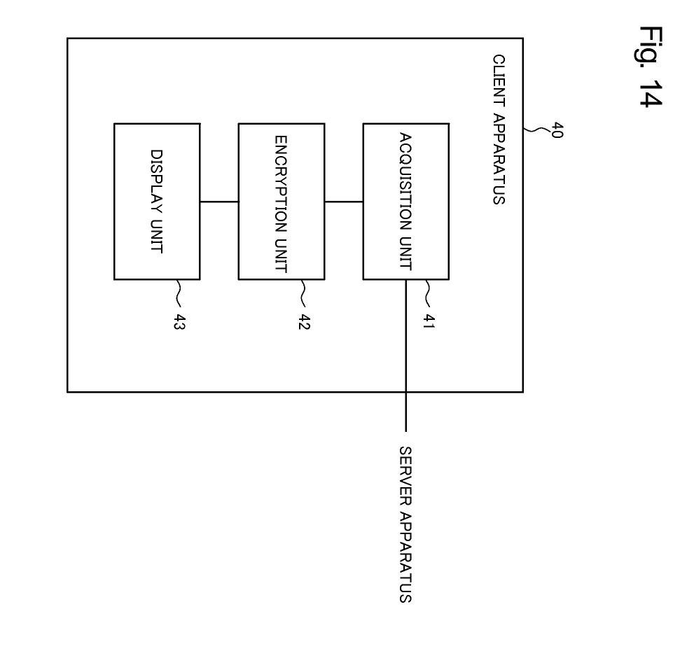

FIG. 14 is a block diagram illustrating an example of the configuration of a client apparatus 40 according to this third exemplary embodiment.

FIG. 13 and FIG. 14 each illustrate components in relation to description of this exemplary embodiment, and omit other components.

The server apparatus 30 includes an encryption unit 31, a first generation unit 32, a second generation unit 33 and a transmission unit 34.

The encryption unit 31 generates information portions on the basis of information resulting from removing the access authority information 310 from the portal page information 300. Then, the encryption unit 31 encrypts the information portions with corresponding encryption keys, and generates encrypted information portions. Then, the encryption unit 31 gives key identifiers to the decryption keys, combines all the information portions such that the key identifier corresponding to each of the information portions and the each of the encrypted information portions form a pair, and generates the encrypted portal page information 800.

Here, the information resulting from removing the access authority information 310 from the portal page information 300 is information which is used for the client apparatus 40 to display contents. And, the encryption with respect to the encrypted portal page information 800 is such a kind of encryption that can be decrypted by the client apparatus to which an access authority is given.

The first generation part 32 encrypts a copy of a decryption key in accordance with an access authority, with a corresponding user's public key on the basis of the access authority information 310, and combines the encrypted copy of a decryption key and its key identifier such that the encrypted copy of a decryption key and its key identifier form a pair.

Here, the encryption key can decrypt a corresponding information portion. And, an encryption key which is encrypted can be decrypted by only a corresponding user's secret key. That is, the encryption key which is encrypted is decryption information for a specific user. The client apparatus 40 for the user who is given the access authority or the client apparatus 40 for other user who is given an equivalent access authority can decrypt (use) this decryption information.

The second generation portion 33 combines the decryption information generated by the first generation unit 32, and generates the all-users decryption information 390.

In this way, the encryption unit 31, the first generation unit 32 and the second generation unit 33 realize the same function as that of the portal information management unit 22 of the first exemplary embodiment in cooperation with one another.

The transmission unit 34 transmits the encrypted information (the encrypted portal page information 800), which corresponds to the request from the client apparatus 40, and the all-users decryption information 390 to the client apparatus 40, just like the portal information transmission unit 26 of the first exemplary embodiment.

In this way, the server apparatus 30 can realize the same advantageous effect as that of the portal server 2 of the first exemplary embodiment.

A reason of this is that the server apparatus 30 can realize the same functions as those of the portal information management unit 22 and the portal information transmission unit 26 of the first exemplary embodiment.

In addition, the configuration of the server apparatus 30 shown in FIG. 13 is a minimum configuration of the server apparatus according to an aspect of the present invention.

The client apparatus 40 includes an acquisition unit 41, a decryption unit 42 and a display unit 43.

The acquisition unit 41 decrypts the all-users decryption information 390 transmitted by the server apparatus 30 with its own secret key. The decryption key for the client apparatus 40 can be decrypted with its own secret key. That is, the acquisition unit 41 acquires its own decryption key (decryption information).

The decryption information decrypted by the acquisition unit 41 is a decryption key which can decrypt partial information, being information which the client apparatus 40 has an access authority to access, of the encrypted portal page information 800.

The decryption unit 42 decrypts information portions with corresponding decryption keys on the basis of key identifiers corresponding to the information portions.

That is, the decryption unit 42 decrypts partial information which is included in the encrypted information received from the server apparatus 30 and which can be decrypted by the client apparatus 40.

In this way, the acquisition unit 41 and the decryption unit 42 realize the same function as that of the portal information decryption unit 113 of the first exemplary embodiment in cooperation with each other.

The display unit 43 combines information which the decryption unit 42 has successfully decrypted, and displays the combined information on a display screen.

The display unit 43 realizes the same functions as those of the content combination unit 116 and the content display unit 117 of the first exemplary embodiment.

The client apparatus 40 can realize the same advantageous effects as those of the client 1 of the first exemplary embodiment.

A reason of this is that the client apparatus 40 can realize the same functions as those of the portal information decryption unit 113, the content combination unit 116 and the content display unit 117 of the client 1 of the first exemplary embodiment.

In addition, the configuration of the client apparatus 40 shown in FIG. 14 is a minimum configuration of a client apparatus according to an aspect of the present invention.

### Modification Example

The server apparatus 30 of this exemplary embodiment may be realized as a computer apparatus including a central processing unit (CPU), a read only memory (ROM), a random access memory (RAM), an input/output circuit (IOC) and a network interface circuit (NIC).

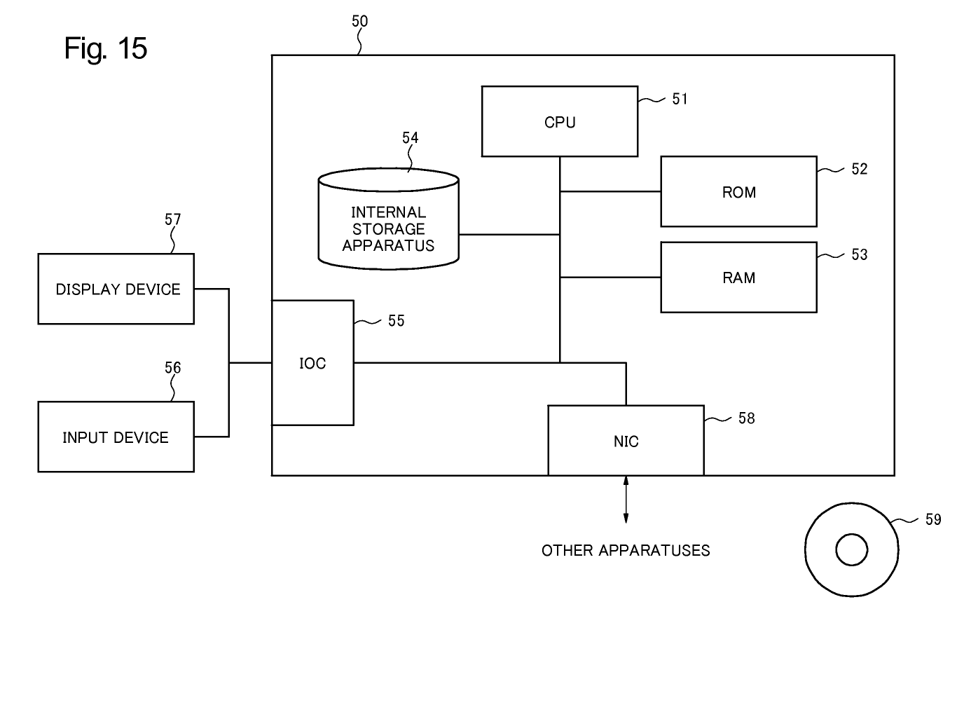

FIG. 15 is a block diagram illustrating an example of the configuration of a server apparatus 50, which is a different configuration of the server apparatus 30 of this exemplary embodiment.

The server 50 includes a CPU 51, a ROM 52, a RAM 53, an internal storage apparatus 54, an IOC 55 and an NIC 58, and constitutes a computer.

The CPU 51 retrieves programs from the ROM 52. Then, the CPU 51 controls the RAM 53, the internal storage apparatus 54, the IOC 55 and the NIC 58 on the basis of the retrieved programs. Then, the CPU 51 controls these components, and realizes the functions as the encryption unit 31, the first generation unit 32, the second generation unit 33 and the transmission unit 34, which are shown in FIG. 13. When realizing these functions, the CPU 51 uses the RAM 53 as a temporary memory for the programs.

Alternatively, the CPU 51 may retrieve programs included in a storage medium 59, which stores programs such that the programs are readable from a computer, by using a storage-medium reading apparatus (not illustrated). Alternatively, the CPU 51 may receive programs from an external apparatus (not illustrated) via the NIC 58.

The ROM 52 stores programs executed by the CPU 51, as well as fixed data. The ROM 52 is, for example, a programmable-ROM (P-ROM) or a flash ROM.

The RAM 53 temporarily stores programs executed by the CPU 51, as well as data used by the CPU 51. The RAM 53 is, for example, a dynamic-RAM (D-RAM).

The internal storage apparatus 54 stores data and programs which the server apparatus 50 stores for a long term. And, the internal storage apparatus 54 may also operate as a temporary storage apparatus for the CPU 51. The internal storage apparatus 54 is, for example, a hard disk apparatus, a magnetic optical disk apparatus, a solid state drive (SSD) or a disk array apparatus.

The IOC 550 intermediates data which is interchanged between the CPU 51 and an input device 56, and data which is interchanged between the CPU 51 and a display device 57. The IOC 55 is, for example, an IO interface card.

The input device 56 is an input unit for receiving input instructions from an operator of the server apparatus 50. The input device 56 is, for example, a keyboard, a mouse device or a touch panel.

The display device 57 is a display unit of the server apparatus 50. The display device 57 is, for example, a liquid crystal display.

The NIC 58 relays data interchange with the client apparatus 40 via networks. The NIC 58 is, for example, a LAN card.

The server apparatus 50, which is configured in such a way as described above, can obtain the same advantageous effects as those of the server apparatus 30.

A reason of this is that the CPU 51 of the server apparatus 50 can realize the same functions as those of the server apparatus 30 on the basis of programs.

And, similarly, the client apparatus 40 may be realized by a computer shown in FIG. 15.

An example of advantageous effects of the present invention is to reduce processing load on a server apparatus at the time when the server apparatus is accessed by a client.

Further, an example of advantageous effects of the present invention is that, when a server apparatus processes a request regarding a web system from a client apparatus of a user, it is possible to, at the client apparatus side, perform processing for determining access authorities for a web page and individual contents included in the web page regarding the client apparatus, and processing for combining the contents.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

The whole or part of the exemplary embodiments disclosed above can be described as, but not limited to, the following supplementary notes.

### (Supplementary Note 1)

A request processing method for a server apparatus which provides contents to a client apparatus on the basis of an access authority which is set on a user of the client apparatus, the request processing method including:

encrypting necessary information for displaying the contents by the client apparatus;

generating decryption information for decrypting encrypted information which is given the access authority for the client apparatus among the encrypted information; and

transmitting the encrypted information and the decryption information to the client apparatus when the client apparatus transmits a request for contents to the server apparatus.

### (Supplementary Note 2)

The request processing method according to supplementary note 1, wherein

the necessary information for displaying contents by the client apparatus includes encrypted information of portal page information for displaying a portal page and portlet information which is arranged in the portal page,

the portal page information includes contents in the portal page and setting information related to a layout of the display screen of the portal page,

the portlet information includes contents in the portlet and setting information related to a layout of the display screen of the portlet,

encrypting the portal information and the portlet information on the basis of the access authority which is specific to the user of the client apparatus, and

transmitting setting information related to the portal page information and the portlet information which are specific to the user of the client apparatus.

### (Supplementary Note 3)

The request processing method according to supplementary note 1, further including:

acquiring external contents of an external server;

encrypting the external contents such that the certain client apparatus can decrypt the encrypted information to which the user of the client apparatus is given the access authority, and

transmitting the encrypted external contents to the client apparatus.

### (Supplementary Note 4)

A server response processing method for a client apparatus which is used in a web system and accesses a server apparatus providing contents on the basis of an access authority set on a user of the client apparatus, the server response processing method including:

acquiring decryption information for the client apparatus which accesses the web system from decryption information received from the server apparatus;

decrypting information which can be decrypted by using the decryption information for the client apparatus among received encrypted information from the server apparatus; and

displaying decrypted information on a display screen.

### (Supplementary Note 5)

The server response processing method according to supplementary note 4, wherein

information received from the server apparatus includes encrypted information of portal page information for displaying a portal page and portlet information for arranged within a display screen of the portal page,

the portal page information includes contents in the portal page and setting information related to a layout of the display screen of the portal page,

the portlet information includes contents in the portlet, setting information related to a layout of the display screen of the portlet, and specific setting information of the portal page information and the portlet information for the user of the client apparatus which accesses the web system, and

configuring and combining the decrypted information in accordance with the setting information related to the portal page information and the portlet information, and the specific setting information related to the portal page information and the portlet information for the user of the client apparatus.

### (Supplementary Note 6)

The server response processing method according to supplementary note 5, wherein

the information received from the server includes encrypted information of external contents of an external server apparatus other than the server apparatus.

### (Supplementary Note 7)

A computer readable medium embodying a program, the program causing a server apparatus which provides contents to a client apparatus on the basis of an access authority which is set on a user of the client apparatus to perform a method, the method including:

encrypting necessary information for displaying the contents by the client apparatus;

generating decryption information for decrypting encrypted information which is given the access authority for the client apparatus among the encrypted information; and

transmitting the encrypted information and the decryption information to the client apparatus when the client apparatus transmits a request for contents to the server apparatus.

### (Supplementary Note 8)

The computer readable medium according to supplementary note 7, wherein

the necessary information for displaying contents by the client apparatus includes encrypted information of portal page information for displaying a portal page and portlet information which is arranged in the portal page,

the portal page information includes contents in the portal page and setting information related to a layout of the display screen of the portal page,

the portlet information includes contents in the portlet and setting information related to a layout of the display screen of the portlet,

encrypting the portal information and the portlet information on the basis of the access authority which is specific to the user of the client apparatus, and

transmitting setting information related to the portal page information and the portlet information which are specific to the user of the client apparatus.

### (Supplementary Note 9)

The computer readable medium according to supplementary note 7, further including:

acquiring external contents of an external server;

encrypting the external contents such that the certain client apparatus can decrypt the encrypted information to which the user of the client apparatus is given the access authority, and

transmitting the encrypted external contents to the client apparatus.

### (Supplementary Note 10)

A computer readable medium embodying a program, the program causing a client apparatus which is used in a web system and displays contents on the basis of an access authority set on a user of the client apparatus to perform a method, the method including;

acquiring decryption information for the client apparatus which accesses the web system from decryption information received from the server apparatus;

decrypting information which can be decrypted by using the decryption information for the client apparatus among received encrypted information from the server apparatus; and

displaying decrypted information on a display screen.

### (Supplementary Note 11)

The computer readable medium according to supplementary note 10, wherein

information received from the server apparatus includes encrypted information of portal page information for displaying a portal page and portlet information for arranged within a display screen of the portal page,

the portal page information includes contents in the portal page and setting information related to a layout of the display screen of the portal page,

the portlet information includes contents in the portlet, setting information related to a layout of the display screen of the portlet, and specific setting information of the portal page information and the portlet information for the user of the client apparatus which accesses the web system, and

configuring and combining the decrypted information in accordance with the setting information related to the portal page information and the portlet information, and the specific setting information related to the portal page information and the portlet information for the user of the client apparatus.

### (Supplementary Note 12)

The computer readable medium according to supplementary note 11, wherein

the information received from the server includes encrypted information of external contents of an external server apparatus other than the server apparatus.

1. A server apparatus which provides contents to a client apparatus on the basis of an access authority which is set on a user of said client apparatus in a web system, said server apparatus comprising:
an encryption unit which encrypts information for displaying the contents by said client apparatus which is given an access authority to the user of said client apparatus, such that the client apparatus can decrypt it;
a first generation unit which generates decryption information for a specific user, the decryption information being used for decrypting the encrypted information which is given the access authority for said client apparatus, and used by said client apparatus for the user who is given the access authority and a client apparatus for other user who is given the access authority same as the user;
a second generation unit which generates decryption information for all the users by combining the decryption information for the specific users according to said client apparatus; and
a transmission unit which transmits the information encrypted by said encryption unit and the decryption information for all the users to said client apparatus in response to the access from said client apparatus.

2. The server apparatus according to claim 1, wherein
the contents displayed by said client apparatus includes portal page information for displaying a portal page, and portlet information for displaying a portlet which is arranged within the portal page,
the portal page information includes contents in the portal page and setting information related to a layout for the display screen for the portal page,
the portlet information includes contents in the portlet and setting information related to a layout of the display screen of the portlet,
said encryption unit encrypts the portal page information and the portlet information on the basis of the access authority of each user of said client apparatus, and
said transmission unit transmits setting information related to the portal page information and the portlet information which are specific to the user of said client apparatus.

3. The server apparatus according to claim 1, wherein
said encryption unit acquires external contents of an external server, and encrypts the external contents such that said client apparatus can decrypt the encrypted information to which the user of said client apparatus is given the access authority, and
said transmission unit transmits the encrypted external contents to said client apparatus.

4. A client apparatus which is used in a web system and displays contents on the basis of an access authority set on a user of said client apparatus, said client apparatus comprising:
an acquisition unit which acquires decryption information for said client apparatus from decryption information received from a server apparatus;
a decryption unit which decrypts information which can be decrypted by using the decryption information for said client apparatus among encrypted information received from said server apparatus; and
a display unit which combines the information decrypted by said decryption unit and displays it on a display screen.

5. The client apparatus according to claim 4, wherein
information received from the server apparatus includes information encrypted portal page information for displaying a portal page and a portlet information for displaying a portlet arranged in the portal page,
the portal page information includes contents in the portal page and setting information related to a layout for the display screen for the portal page,
the portlet information includes contents in the portlet, setting information related to a layout of the display screen of the portlet, and specific setting information of the portal page information and the portlet information for the user of said client apparatus which accesses the web system, and
said display unit configures and combines the decrypted information in accordance with the setting information related to the portal page information and the portlet information, and the specific setting information related to the portal page information and the portlet information for the user of said client apparatus.

6. The client apparatus according to claim 4, wherein
the information received from said server apparatus includes information encrypted external contents of an external server apparatus other than said server apparatus.

7. A request processing method for a server apparatus which provides contents to a client apparatus on the basis of an access authority which is set on a user of said client apparatus, the request processing method comprising:
encrypting necessary information for displaying the contents by said client apparatus;
generating decryption information for decrypting encrypted information which is given the access authority for said client apparatus among the encrypted information; and
transmitting the encrypted information and the decryption information to said client apparatus when said client apparatus transmits a request for contents to said server apparatus.
